(19) United States
(12) Patent Application Publication
(10) Pub. No.: US 2026/0281435 A1
(43) Pub. Date: Sep. 17, 2026

(54) POINT CLOUD CODING METHOD

(71) Applicant: Tencent Technology (Shenzhen) Company Limited, Shenzhen (CN)

(72) Inventors: Wenjie ZHU, Shenzhen (CN); Xiaozhong XU, Shenzhen (CN)

(73) Assignee: Tencent Technology (Shenzhen) Company Limited, Shenzhen, GD (CN)

(21) Appl. No.: 19/672,161

(22) Filed: May 8, 2026

Related U.S. Application Data
(63) Continuation of application No. PCT/CN2024/109313, filed on Aug. 1, 2024.

(30) Foreign Application Priority Data
Nov. 28, 2023 (CN) 202311626550.X

(51) Int. Cl. H04N 19/597; H04N 19/17

(52) U.S. Cl. CPC H04N 19/597; H04N 19/17

(57) ABSTRACT

In a point cloud decoding method, grouping information is determined based on a target feature of a target point cloud, the grouping information including an initial grouping step size associated with the target feature, and the target feature including one or more types of information that include: point cloud characteristic information, bounding box information, coding parameter information, or target parameter information. In the method, reconstructed position points are decoded from a geometry bitstream of the target point cloud. In the method, the reconstructed position points are grouped into a plurality of groups of position points based on the grouping information. In the method, attributes of each group of the plurality of groups of position points are decoded from an attribute bitstream of the target point cloud. In the method, reconstructed points of the target point cloud are obtained based on the reconstructed position points and the decoded attributes.

### RELATED APPLICATIONS

The present application is a continuation of International Application No. PCT/CN2024/109313, filed on Aug. 1, 2024, which claims priority to Chinese Patent Application No. 202311626550.X, filed on Nov. 28, 2023, and entitled “POINT CLOUD DECODING METHOD, POINT CLOUD ENCODING METHOD, DECODER, ELECTRONIC DEVICE, AND MEDIUM.” The entire disclosures of the prior applications are hereby incorporated by reference.

### FIELD OF THE TECHNOLOGY

Embodiments of this disclosure relate to the technical field of point cloud encoding and decoding, including a point cloud decoding method, a point cloud encoding method, a decoder, an electronic device, and a non-transitory computer-readable storage medium.

### BACKGROUND

In a related point cloud encoding/decoding technology, after completing geometry encoding, an encoder groups reconstructed position points according to a fixed formula, to perform attribute encoding based on each group of reconstructed position points. Similarly, after completing the geometry decoding, the decoder groups the reconstructed position points according to a preset formula, and performs attribute decoding based on each group of reconstructed position points. A grouping method provided in some applications is limited, which is not beneficial to improving encoding/decoding performance of a point cloud.

### SUMMARY

This disclosure provides a point cloud decoding method, a point cloud encoding method, a decoder, an electronic device, and a non-transitory computer-readable storage medium, to improve encoding/decoding performance of a point cloud at least to some extent.

In a first aspect, this disclosure provides a point cloud decoding method. In the method, grouping information is determined based on a target feature of a target point cloud, the grouping information including an initial grouping step size associated with the target feature, and the target feature including one or more types of information that include: point cloud characteristic information, bounding box information, coding parameter information, or target parameter information. In the method, reconstructed position points are decoded, by processing circuitry, from a geometry bitstream of the target point cloud. In the method, the reconstructed position points are grouped, by the processing circuitry, into a plurality of groups of position points based on the grouping information. In the method, attributes of each group of the plurality of groups of position points are decoded from an attribute bitstream of the target point cloud. In the method, reconstructed points of the target point cloud are obtained based on the reconstructed position points and the decoded attributes.

In a second aspect, this disclosure provides a point cloud encoding method. In the method, grouping information is determined based on a target feature of a target point cloud, the grouping information including an initial grouping step size associated with the target feature, and the target feature including one or more types of information that include: point cloud characteristic information, bounding box information, coding parameter information, or target parameter information. In the method, predicted attributes of the target point cloud and corresponding reconstructed position points of the target point cloud are determined by processing circuitry. In the method, the reconstructed position points are grouped, by the processing circuitry, into a plurality of groups of position points based on the grouping information. In the method, the reconstructed position points are encoded into a geometry bitstream of the target point cloud. In the method, the respective attributes of each group of the plurality of groups of position points are encoded into an attribute bitstream of the target point cloud.

In a third aspect, this disclosure provides a point cloud decoding apparatus. The point cloud decoding apparatus including processing circuitry configured to determine grouping information based on a target feature of a target point cloud, the grouping information including an initial grouping step size associated with the target feature, and the target feature including one or more types of information that include: point cloud characteristic information, bounding box information, coding parameter information, or target parameter information. The processing circuitry is configured to decode reconstructed position points from a geometry bitstream of the target point cloud. The processing circuitry is configured to group the reconstructed position points into a plurality of groups of position points based on the grouping information. The processing circuitry is configured to decode attributes of each group of the plurality of groups of position points from an attribute bitstream of the target point cloud. The processing circuitry is configured to obtain reconstructed points of the target point cloud based on the reconstructed position points and the decoded attributes.

In a fourth aspect, this disclosure provides a point cloud encoding apparatus. The point cloud encoding apparatus including processing circuitry configured to determine grouping information based on a target feature of a target point cloud, the grouping information including an initial grouping step size associated with the target feature, and the target feature including one or more types of information that include: point cloud characteristic information, bounding box information, coding parameter information, or target parameter information. The processing circuitry is configured to determine predicted attributes of the target point cloud and corresponding reconstructed position points of the target point cloud. The processing circuitry is configured to group the reconstructed position points into a plurality of groups of position points based on the grouping information. The processing circuitry is configured to encode the reconstructed position points into a geometry bitstream of the target point cloud. The processing circuitry is configured to encode the respective attributes of each group of the plurality of groups of position points into an attribute bitstream of the target point cloud.

In a fifth aspect, this disclosure provides a non-transitory computer-readable storage medium storing instructions, which when executed by a processor, cause the processor to perform a point cloud decoding method. In the method, grouping information is determined based on a target feature of a target point cloud, the grouping information including an initial grouping step size associated with the target feature, and the target feature including one or more types of information that include: point cloud characteristic information, bounding box information, coding parameter information, or target parameter information. In the method, reconstructed position points are decoded from a geometry bitstream of the target point cloud. In the method, the reconstructed position points are grouped into a plurality of groups of position points based on the grouping information. In the method, attributes of each group of the plurality of groups of position points are decoded from an attribute bitstream of the target point cloud. In the method, reconstructed points of the target point cloud are obtained based on the reconstructed position points and the decoded attributes.

In a sixth aspect, this disclosure provides a non-transitory computer-readable storage medium storing instructions, which when executed by a processor, cause the processor to perform a point cloud encoding method. In the method, grouping information is determined based on a target feature of a target point cloud, the grouping information including an initial grouping step size associated with the target feature, and the target feature including one or more types of information that include: point cloud characteristic information, bounding box information, coding parameter information, or target parameter information. In the method, predicted attributes of the target point cloud and corresponding reconstructed position points of the target point cloud are determined. In the method, the reconstructed position points are grouped into a plurality of groups of position points based on the grouping information. In the method, the reconstructed position points are encoded into a geometry bitstream of the target point cloud. In the method, the respective attributes of each group of the plurality of groups of position points are encoded into an attribute bitstream of the target point cloud.

In a seventh aspect, this disclosure provides a point cloud decoding method, performed by a processor, the method including: determining grouping information based on a target feature of a target point cloud, where the target feature includes one or more of the following information: point cloud characteristic information, bounding box information, coding parameter information, and target parameter information; grouping first reconstructed position points based on the grouping information to obtain a plurality of groups, where the first reconstructed position points are obtained by decoding a geometry bitstream of the target point cloud through a decoder; and performing attribute decoding on each group.

In an eighth aspect, this disclosure provides a point cloud encoding method, performed by a processor, the method including: determining grouping information based on a target feature of a target point cloud, where the target feature includes one or more of the following information: point cloud characteristic information, bounding box information, coding parameter information, and target parameter information; grouping second reconstructed position points based on the grouping information to obtain a plurality of groups, where the second reconstructed position points are encoded into a geometry bitstream of the target point cloud through an encoder; and performing attribute encoding on each group.

In a ninth aspect, this disclosure provides a decoder, the decoder including: a first determining module, a decoding grouping module, and an attribute decoding module, where the first determining module is configured to determine grouping information based on a target feature of a target point cloud, where the target feature includes one or more of the following information: point cloud characteristic information, bounding box information, coding parameter information, and target parameter information; the decoding grouping module is configured to group first reconstructed position points based on the grouping information to obtain a plurality of groups, where the first reconstructed position points are obtained by decoding a geometry bitstream of the target point cloud through the decoder; and the attribute decoding module is configured to perform attribute decoding on each group.

In a tenth aspect, this disclosure provides a decoder, including processing circuitry (e.g., a processor) and a memory (e.g., including a non-transitory computer-readable storage medium); the memory being configured to store a computer program; and the processor being configured to execute the computer program to implement the point cloud decoding method provided in the first aspect.

In an eleventh aspect, this disclosure provides an encoder, including: a second determining module, an encoding grouping module, and an attribute encoding module, where the second determining module is configured to determine grouping information based on a target feature of a target point cloud, where the target feature includes one or more of the following information related to encoding the target point cloud or defaulted by an encoder side: point cloud characteristic information, bounding box information, coding parameter information, and target parameter information; the encoding grouping module is configured to group second reconstructed position points based on the grouping information to obtain a plurality of groups, where the second reconstructed position points are encoded into a geometry bitstream of the target point cloud through the encoder; and the attribute prediction module is configured to perform attribute encoding on each group.

In a twelfth aspect, this disclosure provides an encoder, including a processor and a memory, the memory being configured to store a computer program; and the processor being configured to execute the computer program to implement the point cloud encoding method provided in one or more aforementioned aspects.

In a thirteenth aspect, this disclosure provides an electronic device, including processing circuitry (e.g., a processor) and a memory (e.g., including a non-transitory computer-readable storage medium), the memory being configured to store a computer program; and the processor being configured to execute the computer program to implement the point cloud decoding method or the point cloud encoding method provided in one or more aforementioned aspects.

In a fourteenth aspect, this disclosure provides a chip, configured to implement the method provided in one or more aforementioned aspects. In at least one embodiment, the chip includes processing circuitry (e.g., a processor), configured to invoke a computer program from a memory (e.g., including a non-transitory computer-readable storage medium) and run the computer program, so that a device having the chip installed therein performs the method provided in the first aspect or in the second aspect.

In a fifteenth aspect, this disclosure provides a non-transitory computer-readable storage medium, configured to store a computer program, the computer program causing a computer to perform the method provided in one or more aforementioned aspects.

In a sixteenth aspect, this disclosure provides a computer program product, including computer program instructions, the computer program instructions causing a computer to perform the method provided in one or more aforementioned aspects.

In a seventeenth aspect, this disclosure provides a computer program. When running on a computer, the computer program causes the computer to perform the method provided in one or more aforementioned aspects.

In the point cloud decoding solution provided in aspects of this disclosure, the grouping information is determined based on the target feature of the target point cloud. In an attribute decoding process, the decoder groups the first reconstructed position points based on the grouping information to obtain a plurality of groups. The first reconstructed position points are obtained by decoding the geometry bitstream of the target point cloud through the decoder. Further, the decoder performs attribute decoding on each group. In the decoding solution provided in this disclosure, the decoder determines the grouping information based on one or more of the following information defaulted by the encoder/decoder side or obtained by parsing the bitstream of the target point cloud: the point cloud characteristic information, the bounding box information, the coding parameter information, and target parameter information. It can be learned that in this disclosure, the grouping information is determined based on diversified features related to the target point cloud, so that grouping diversity can be enhanced, thereby facilitating improvement in decoding performance of the point cloud.

Similarly, in the point cloud encoding solution provided in this disclosure, the grouping information is determined based on the target feature of the target point cloud. In an attribute encoding process, the encoder groups the second reconstructed position points based on the grouping information to obtain a plurality of groups. The second reconstructed position points are encoded in the geometry bitstream of the target point cloud through the encoder. Further, the encoder performs attribute encoding on each group. In the encoding solution provided in this disclosure, the encoder determines the grouping information based on one or more of the following information defaulted by the encoder/decoder side or related to encoding the bitstream of the target point cloud: the point cloud characteristic information, the bounding box information, the coding parameter information, and the target parameter information. It can be learned that in this disclosure, the grouping information is determined based on diversified features related to the target point cloud, so that grouping diversity can be enhanced, thereby facilitating improvement in encoding performance of the point cloud.

### BRIEF DESCRIPTION OF THE DRAWINGS

To describe the technical solutions in embodiments of this disclosure, the following briefly describes the accompanying drawings for describing one or more embodiments in this disclosure. The accompanying drawings in the following description show merely some embodiments of this disclosure, and a person of ordinary skill in the art may still derive other drawings from these accompanying drawings.

FIG. 1 is a schematic diagram of a network architecture of point cloud encoding/decoding according to an embodiment of this disclosure.

FIG. 2 is a schematic block diagram of a point cloud video encoding/decoding system according to an embodiment of this disclosure.

FIG. 3A is a schematic block diagram of an encoding framework according to an embodiment of this disclosure.

FIG. 3B is a schematic block diagram of a decoding framework according to an embodiment of this disclosure.

FIG. 4 is a schematic flowchart of a point cloud decoding method according to an embodiment of this disclosure.

FIG. 5 is a schematic diagram of a point cloud bounding box according to an embodiment of this disclosure.

FIG. 6 is a schematic flowchart of a point cloud decoding method according to another embodiment of this disclosure.

FIG. 7 is a schematic flowchart of a point cloud encoding method according to an embodiment of this disclosure.

FIG. 8 is a schematic flowchart of a point cloud encoding method according to another embodiment of this disclosure.

FIG. 9 is a schematic structural diagram of a decoder according to an embodiment of this disclosure.

FIG. 10 is a schematic structural diagram of an encoder according to an embodiment of this disclosure.

FIG. 11 is a schematic structural diagram of an electronic device according to an embodiment of this disclosure.

FIG. 12 is a schematic structural diagram of an encoding/decoding system according to an embodiment of this disclosure.

### DETAILED DESCRIPTION

The technical solutions in embodiments of this disclosure are described in the following with reference to the accompanying drawings in this disclosure. The described embodiments are merely some rather than all of the embodiments of this disclosure. Other embodiments fall within the scope of this disclosure.

Descriptions of terms in this disclosure are provided as examples and are not intended to limit the scope of the disclosure.

Terms such as “first” and “second” in the specification and claims of this disclosure and the above drawings are used for distinguishing similar objects, and are not necessarily used for describing a specific order or sequence. Data used in this way is exchangeable in a proper case, so that embodiments of this disclosure described herein can be implemented in an order different from the order shown or described herein. In one or more embodiments of this disclosure, “B corresponding to A” indicates that B is associated with A. In an implementation, B may be determined based on A. However, the fact that “B is determined based on A” does not mean that the B is determined only based on A and may further be determined based on A and/or another information. In addition, the terms such as “include” and “have” and any variations thereof are intended to cover non-exclusive inclusion, for example, a process, method, system, product, or server including a series of operations or elements is not necessarily limited to those operations or elements that are listed, but may include other operations or elements that are not listed or inherent to these processes, methods, products, or devices. In the description of this disclosure, unless otherwise specified, “a plurality of” means two or more than two.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In one or more embodiments of this disclosure, the term such as “module” or “unit” refers to a computer program having a preset function or a part of a computer program, and works together with other relevant parts to achieve a preset objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an integrated module or unit including a function of the module or the unit.

A point cloud may correspond to a set of discrete points that are irregularly distributed in a space and express a spatial structure and a surface attribute of a three-dimensional object or scene.

Point cloud data may correspond to a recording form of a point cloud. In some aspects, the point cloud data may record position information and attribute information of each point in the point cloud. The position information of the point may be three-dimensional coordinate information of the point. The position information of the point may alternatively be referred to as geometry information of the point. The attribute information of the point may include color information and/or reflectivity information. The color information may be information in any color space. For example, the color information may be RGB. “R” denotes red (R), “G” denotes green (G), and “B” denotes blue (B). For another example, the color information may be luminance chrominance (YCbCr, YUV) information, where “Y” denotes a luminance (Luma), “Cb (U)” denotes a blue color difference, and “Cr (V)” denotes a red color difference.

For example, the point cloud data of a point cloud acquired based on a laser measurement principle may include three-dimensional coordinate information of a point and laser reflectance of the point. For another example, points in a point cloud acquired based on a photogrammetry principle may include three-dimensional coordinate information of the point and color information of the point. For another example, a point cloud is acquired by based on laser measurement and photogrammetry principles, and points in the point cloud may include three-dimensional coordinate information of the points, laser reflectance of the points, and color information of the points.

Approaches for acquiring the point cloud data may include, but are not limited to, at least one of the following: (1) generation by a computer device: the computer device may generate the point cloud data based on a virtual three-dimensional object and a virtual three-dimensional scene; (2) acquisition via three-dimension (3D) laser scanning: the point cloud data of a static real-world three-dimensional object or scene may be acquired through 3D laser scanning, and millions of point cloud data may be acquired per second; (3) acquisition via 3D photogrammetry: a visual scene of a real world is collected by using 3D photographic equipment (i.e., a set of cameras or a camera device with multiple lenses and sensors) to acquire the point cloud data of the visual scene of the real world, and the point cloud data of a dynamic real-world three-dimensional object or three-dimensional scene may be obtained by 3D photography; or (4) obtaining point cloud data of living tissues and organs by using a medical device; in the medical field, the point cloud data of the living tissues and organs may be acquired by the medical device such as magnetic resonance imaging (MRI), computed tomography (CT), and electromagnetic positioning information.

The point cloud may be classified into a static point cloud, a dynamic point cloud, and a dynamically-acquired point cloud based on an acquisition approach. The static point cloud refers to the fact that both an object and a device for acquiring the point cloud are stationary when the point cloud is acquired. The dynamic point cloud refers to the fact that when the point cloud is acquired, the object is in motion but the device for acquiring the point cloud is stationary. The dynamically-acquired point cloud refers to the fact that the device for acquiring the point cloud is in motion when the point cloud is acquired.

In addition, the point cloud is classified into two types based on applications of the point cloud: a machine perception point cloud and an eye perception point cloud. The machine perception point cloud may be applied to scenarios such as an autonomous navigation system, a real-time routing inspection system, a geographical information system, a visual sorting robot, and a disaster-rescue robot. The human perception point cloud may be applied to point cloud application scenarios such as digital cultural heritage, free-viewpoint broadcasting, three-dimensional immersive communication, and three-dimensional immersive interaction.

The point cloud may flexibly and conveniently express a spatial structure and a surface attribute of a three-dimensional object or scene. Moreover, since the point cloud is obtained by directly sampling a real object, and an extremely strong sense of reality can be provided while ensuring the accuracy, the point cloud is widely applied to a virtual reality game, computer-aided design, a geographical information system, an automatic navigation system, digital cultural heritage, free-viewpoint broadcasting, three-dimensional immersive remote presentation, three-dimensional reconstruction of living tissues and organs, and the like. With changes of a point cloud data acquiring method, a large amount of point cloud data may be acquired. However, with increase of application demands, processing of massive point cloud data encounters bottlenecks of limited storage space and transmission bandwidth.

For example, taking a point cloud video with a frame rate of 30 frames per second (FPS) as an example, each frame of point cloud contains 600,000 points. Each point has coordinate information xyz (float) and color information RGB (uchar). Therefore, a data volume of a point cloud video with a duration of 15 s is approximately 0.6 million×(4 Byte×3+1 Byte×3)×30 fps×10 s=4.05 GB. It can be learned that the data volume of the point cloud video is relatively large. Therefore, to save storage space and reduce data transmission flow and transmission time of the point cloud data, the point cloud data needs to be compressed.

Currently, point cloud compression may be achieved by using a point cloud encoding/decoding framework such as geometry-based point cloud compression (G-PCC) or video-based point cloud compression (V-PCC) frameworks provided by the moving picture experts group (MPEG), or an AVS-PCC encoding/decoding framework provided by the audio video coding standard (AVS) In at least one aspect, the G-PCC encoding/decoding framework may be configured to compress a first type of static point clouds and the third type of dynamically-acquired point clouds, and may be implemented based on a point cloud compression test platform (Test Model Compression 13, TMC13). The V-PCC encoding/decoding framework may be configured to compress the second type of dynamic point clouds, and may be implemented based on the point cloud compression test platform (Test Model Compression 2, TMC2). Therefore, the G-PCC encoding/decoding framework is alternatively referred to as a point cloud codec TMC13, and the V-PCC encoding/decoding framework is alternatively referred to as a point cloud codec TMC2.

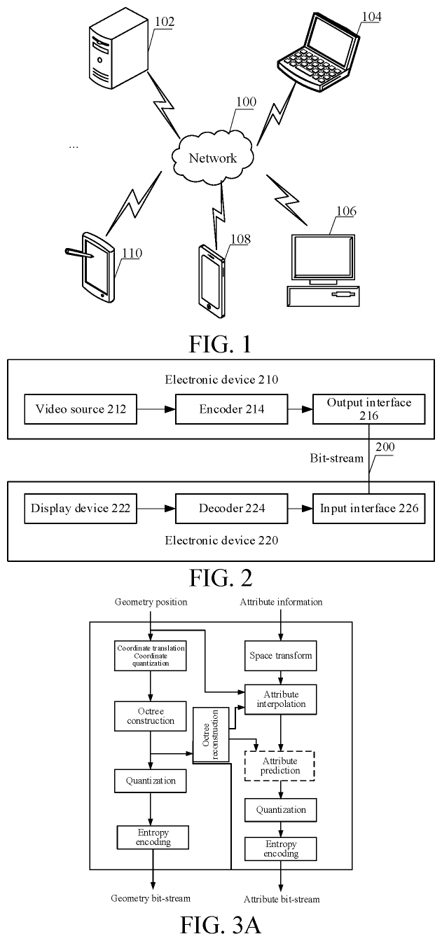

FIG. 1 is a schematic diagram of a network architecture of point cloud encoding/decoding according to an embodiment of this disclosure. A network architecture of a point cloud encoding/decoding system including a decoding method and an encoding method provided in an embodiment of this disclosure is shown as an example.

Referring to FIG. 1, the network architecture includes a communication network 100 and one or more electronic devices. The electronic device may be a server 102, a notebook computer 104, a desktop computer 106, a mobile phone 108, a tablet computer 110, and the like shown in FIG. 1. In at least one aspect, video transmission and interaction may be performed between the electronic devices by using the communication network 100. During implementation, the electronic device may be various types of devices having a point cloud encoding/decoding function. For example, the electronic devices may include smart phones, desktop computers, mobile computing devices, notebook computers (such as a laptop), tablet computers, set-up boxes, televisions, cameras, display devices, digital media players, video game consoles, in-vehicle computers, navigators, digital phones, video phones, television sets, sensing devices, servers, and the like. This is not limited in this disclosure. A decoder or an encoder in this disclosure may be the electronic device. The electronic device in this disclosure has a point cloud encoding/decoding function, and may include a point cloud encoder (which may be referred to as an encoder in this disclosure) and a point cloud decoder (which may be referred to as a decoder in this disclosure).

FIG. 1 is merely an example of the network structure of point cloud encoding/decoding according to an embodiment of this disclosure. The network structure of point cloud encoding/decoding according to an embodiment of this disclosure includes but is not limited to that shown in FIG. 1.

FIG. 2 is a schematic block diagram of a point cloud encoding/decoding system according to an embodiment of this disclosure.

Referring to FIG. 2, for example, the point cloud encoding/decoding system includes two electronic devices: an electronic device 210 (such as an encoder) serving as an encoder side and an electronic device 220 (such as a decoder) serving as a decoder side. The electronic device 210 is configured to encode point cloud data to generate a bitstream and transmit the bitstream to the electronic device 220. The electronic device 220 decodes the received bitstream to obtain decoded point cloud data.

In some embodiments, the bitstream generated by the electronic device 210 through encoding may be transmitted to the electronic device 220 via a channel 200. The channel 200 may include one or more media and/or apparatuses capable of transmitting the encoded point cloud data from the electronic device 210 to the electronic device 220.

In an example, the channel 200 includes one or more communication media enabling the electronic device 210 to directly transmit the encoded point cloud data to the electronic device 220 in real time. In this example, the electronic device 210 may modulate the encoded point cloud data based on a communication standard and transmit the modulated point cloud data to the electronic device 220. The communication medium includes a wireless communication medium, such as a radio frequency spectrum. In some embodiments, the communication medium may further include a wired communication medium, such as one or more physical transmission lines.

In another example, the channel 200 includes a storage medium. The storage medium may store point cloud data encoded by the electronic device 210. The storage medium includes various local access data storage media such as an optical disc, a DVD, and a flash memory. In this example, the electronic device 220 may acquire the encoded point cloud video data from the storage medium.

In another example, the channel 200 may include a storage server. The storage server may store the point cloud data encoded by the electronic device 210. In this example, the electronic device 220 may download the stored encoded point cloud data from the storage server. In some embodiments, the storage server may store the encoded point cloud data and may transmit the encoded point cloud data to the electronic device 220, such as a web server (for example, for a website) or a file transfer protocol (FTP) server.

In some embodiments, the electronic device 210 includes an encoder 214 and an output interface 216. The output interface 216 may include a modulator/demodulator (modem) and/or a transmitter.

In some embodiments, besides the encoder 214 and the output interface 216, the electronic device 210 may further include a point cloud source 212. The point cloud source 212 may include at least one of a point cloud collection apparatus (such as a scanner), a point cloud file, a point cloud input interface, or a computer graphics system. The point cloud input interface is configured to receive point cloud data from a point cloud content provider. The computer graphics system is configured to generate the point cloud data. The encoder 214 encodes the point cloud data from the point cloud source 212, to generate a bitstream. The encoder 214 directly/indirectly transmits the encoded point cloud data to the electronic device 220 via the output interface 216. The encoded point cloud data may further be stored in a storage medium or a storage server, so as to be read by the electronic device 220 subsequently.

In some embodiments, besides the input interface 226 and the decoder 224, the electronic device 220 may further include a display apparatus 222. The input interface 226 includes a receiver and/or a modem. The input interface 226 may receive the encoded point cloud data through the channel 200. The decoder 224 is configured to decode the encoded point cloud data to obtain decoded point cloud data, and transmit the decoded point cloud data to the display apparatus 222. The display apparatus 222 displays the decoded point cloud data. The display apparatus 222 may be integrated with the electronic device 220 or located outside the electronic device 220. The display apparatus 222 may include various display apparatuses such as a liquid crystal display (LCD), a plasma display, an organic light-emitting diode (OLED) display, or another type of display apparatus.

FIG. 2 is merely an example of a point cloud encoding/decoding system according to an embodiment of this disclosure. The point cloud encoding/decoding system according to an embodiment of this disclosure includes but is not limited to that shown in FIG. 2.

FIG. 3A is a schematic block diagram of an encoding framework according to an embodiment of this disclosure.

Referring to FIG. 3A, an encoding framework may acquire geometry information (alternatively referred to as position information or a geometry position) and attribute information of a point cloud from a collection device. The point cloud encoding includes position encoding and attribute encoding.

### (1) Position Encoding

A position encoding process includes: performing preprocessing, such as coordinate translation and coordinate quantization, on an original point cloud. By performing coordinate transform on the original point cloud, a world coordinate of a point in the point cloud may be transformed into a relative coordinate. Coordinate quantization may reduce the number of coordinates. After quantization, the points originally on different positions may be endowed with same coordinates, and the same coordinates may be referred to as repeated points.

The position encoding process further includes: octree (octree) construction: the position information of the quantized point may be encoded in an octree encoding mode. For example, the point cloud is partitioned in a form of an octree. Therefore, positions of the points may be in a one-to-one correspondence with a position of the octree. By performing statistics on positions of points in the octree, a flag of the point position is written as 1.

In addition to the octree encoding mode, the geometry encoding further includes trigonometric representation-based geometry encoding (Trisoup). In at least one aspect, in the trigonometric representation-based encoding mode, the point cloud is partitioned into blocks of a particular size, an intersection of a surface of the point cloud on an edge of the block is positioned, and a triangle is constructed. The geometry information is compressed by encoding the intersection position.

The position encoding process further includes quantization, where fineness of the quantization may be determined by a quantization parameter (QP). A larger value of the QP indicates that coefficients in a larger value range are to be quantized into a same output, which therefore usually brings greater distortion and a lower bit rate. Conversely, a smaller value of the QP indicates that coefficients in a smaller value range are to be quantized into a same output, which therefore usually brings less distortion and a higher bit rate.

The position encoding process further includes entropy encoding. An entropy encoding mode may be employed to perform arithmetic encoding on the position information obtained by constructing the octree, namely, the position information obtained after the octree is constructed employs an arithmetic encoding mode to generate a geometry bitstream, which is alternatively referred to as a geometry bitstream.

The position encoding process further includes octree reconstruction. The position information obtained from octree construction is reconstructed to reconstruct the geometry positions of the points in the point cloud, thereby obtaining reconstructed geometry positions of the points. In at least one aspect, the reconstructed geometry positions of the points are configured for an attribute encoding process.

### (2) Attribute Encoding

An attribute encoding process includes space transform, which may be employed to transform an RGB color space of points in the point cloud into a YCbCr format or another format.

The attribute encoding process includes attribute interpolation.

Attribute recoloring may be achieved by using attribute interpolation. In a case of lossy encoding, after the geometry encoding is performed, an encoder side needs to decode and reconstruct the geometry information. To be specific, three-dimensional coordinate information of each point in the point cloud is recovered. The original point cloud data is searched for attribute information corresponding to one or more neighboring points, and the attribute information serves as attribute information of the reconstructed point. The attribute interpolation may be configured for transforming the attribute information of points in the point cloud, to minimize attribute distortion. In at least one aspect, after attribute interpolation, a true value of the attribute information of the point may be obtained.

The attribute encoding process further includes: attribute prediction. The attribute prediction in this stage may be configured for predicting attribute information of points in the point cloud, to obtain predicted values of the attribute information of the points. For example, based on proximity relationships of geometry information or attribute information, the attribute predicted values of one or more reconstructed position points are selected, and weighted averaging is performed to obtain an attribute predicted value of the current point. Further, a residual value of the attribute information of the point is obtained based on the predicted value of the attribute information of the point. The residual value of the attribute information of the point may be obtained by subtracting the predicted value of the attribute information of the point from a true value of the attribute information of the point.

For example, attribute transform encoding includes three modes, which may be used under different conditions.

(a) Predicting transform encoding: a subset of points is selected based on a distance, and the point cloud is partitioned into multiple levels of detail (LoD), thereby achieving a coarse-to-fine representation of the point cloud. Bottom-up prediction may be implemented between adjacent layers. To be specific, attribute information of a point introduced in a refined layer is predicted from a neighboring point in a coarse layer, to obtain a corresponding residual signal. A point at the bottom layer is used as reference information for encoding.

(b) Lifting transform encoding: based on LoD adjacent layer prediction, a weight update policy of a neighborhood point is introduced, to finally obtain a predicted attribute value of each point and obtain the corresponding residual signal.

(c) Region adaptive hierarchical transform (RAHT) encoding: after the attribute information undergoes the RAHT, a signal is converted into a transform domain, which is referred to as a transform coefficient.

The attribute encoding process further includes: quantization and entropy encoding. In at least one aspect, residual values of the attribute information of the points may be quantized. Further, for the quantized residual values, entropy encoding may be performed on the residual values of the attribute information of the points by employing zero-run length encoding, to obtain an attribute bitstream, which is alternatively referred to as an attribute bitstream.

FIG. 3B is a schematic block diagram of a decoding framework according to an embodiment of this disclosure.

Referring to FIG. 3B, after acquiring a bitstream of a point cloud, a decoding framework parses the bitstream to obtain position information and attribute information of a point in the point cloud. Decoding of the point cloud includes position decoding and attribute decoding.

A position decoding process includes: arithmetic decoding is performed on a geometry bitstream; and octree is constructed and merged to reconstruct the position information of the point, so as to obtain reconstructed information of the position information of the point; and coordinate transform is performed on the reconstructed information of the position information of the point, to obtain the position information of the point. The position information of the point may alternatively be referred to as geometry information of the point.

The attribute decoding process includes: a residual value of the attribute information of a point in the point cloud is acquired by parsing an attribute bitstream; inverse quantization is performed on the residual value of the attribute information of the point to obtain a residual value of the attribute information of the point after the inverse quantization; and one of three prediction modes is selected to perform point cloud prediction based on the reconstructed information of the position information of the point acquired during the position decoding process to obtain a reconstructed value of the attribute information of the point; and color space inverse-conversion is performed on the reconstructed value of the attribute information of the point, to obtain a decoded point cloud.

In a related point cloud encoding/decoding technology, referring to FIG. 3A, in an attribute prediction stage (as shown by a dashed box in FIG. 3A), reconstructed position points may be grouped based on a fixed formula, and attribute encoding is performed based on the reconstructed position points included in each group. Referring to FIG. 3B, after completing geometry decoding, the decoder groups the reconstructed position points based on a preset formula in an attribute reconstruction stage (as shown by a dashed box in FIG. 3B). It can be seen that, in the attribute prediction stage of the encoding process and in the attribute reconstruction stage of the decoding process, the grouping mode provided in some applications is limited, which is not conducive to improving the encoding/decoding performance of the point cloud.

The solutions provided in the embodiments of this disclosure can resolve problems identified above. The following first describes the point cloud decoding method provided in one or more embodiments of this disclosure.

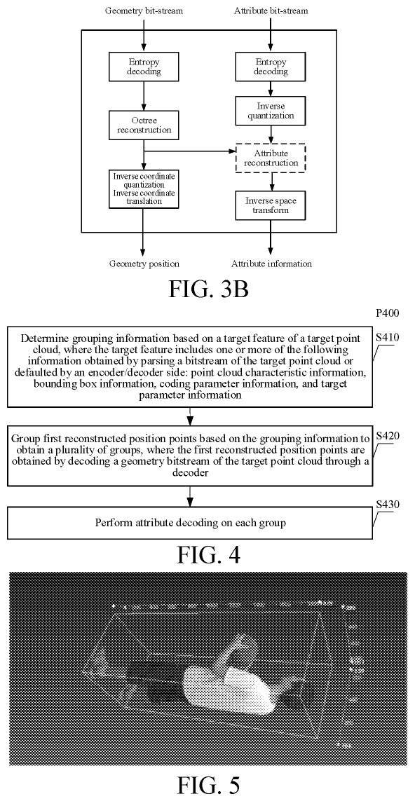

FIG. 4 is a schematic flowchart of a point cloud decoding method P400 according to an embodiment of this disclosure. The point cloud decoding method P400 may be performed by a decoder, or may be performed by an electronic device or a processor executing a decoding process. Referring to FIG. 4, the point cloud decoding method P400 includes operation S410 to operation S430.

S410: Determine grouping information according to a target feature of a target point cloud, where the target feature includes one or more of the following information obtained by parsing a bitstream of the target point cloud or defaulted by an encoder/decoder side: point cloud characteristic information, bounding box information, coding parameter information, and target parameter information. For example, grouping information is determined based on a target feature of a target point cloud, the grouping information including an initial grouping step size associated with the target feature, and the target feature including one or more types of information that include: point cloud characteristic information, bounding box information, coding parameter information, or target parameter information.

The target point cloud is any point cloud data, for example, may be point cloud data corresponding to a video frame.

Before an encoder preprocesses the target point cloud, whether a whole point cloud sequence is partitioned into a plurality of point cloud slices may be determined based on a parameter configuration. In a case where the whole point cloud sequence is determined to be partitioned into a plurality of point cloud slices based on the parameter configuration, each point cloud slice may be treated as a single independent point cloud for serial processing. Therefore, in some embodiments, the target point cloud may be a whole-level point cloud. In some embodiments, the target point cloud may alternatively be a point cloud slice obtained by partitioning the whole-level point cloud sequence, namely, the target point cloud may be a slice-level point cloud.

Similarly, the target feature may be a feature of a whole-level point cloud, or may be a feature of a slice-level point cloud. For example, if the target feature is a point cloud density, then if the target point cloud is the whole-level point cloud, the target feature refers to the density of the whole-level point cloud; if the target point cloud is the slice-level point cloud, the target feature refers to the density of a point cloud slice obtained by partitioning the whole-level point cloud.

In an embodiment of this disclosure, after receiving the bitstream of the target point cloud, the decoder may obtain the target feature by parsing the bitstream, such as obtaining one or more of the following information: point cloud characteristic information, bounding box information, coding parameter information, and target parameter information.

In another embodiment of this disclosure, the target feature may alternatively be default information on the encoder/decoder side. Furthermore, the decoder may further loop up a preset table to determine the target feature, where the preset table is generated before or when the target point cloud is encoded. Default parameters on the encoder/decoder side refer to information that is mutually defaulted by the encoder side and the corresponding decoder side, and refer to information that does not need to be encoded/decoded in a point cloud encoding/decoding process. The target parameter information may include a constant value (or referred to as a fixed value or a default value), and may further include at least one preset identifier, where each preset identifier corresponds to a fixed value.

For example, in an embodiment, the coding parameter information refers to a feature parameter employed when the target point cloud is decoded, and may include one or more of the following information: an attribute prediction transform maximum transform order, an attribute output bit depth, and an attribute quantization parameter that are obtained by decoding an attribute bitstream through the decoder; and a geometry output bit depth and a geometry quantization parameter that are obtained by decoding a geometry bitstream through the decoder. The coding parameter information may further include: a transform method, a prediction method, an ordering method, and the like.

In an embodiment, the point cloud characteristic information may reflect a characteristic of the target point cloud, for example, may include one or more of the following information: a point cloud type, a point cloud density, a point cloud space occupation ratio, a resolution, and a number of point cloud points.

As described above, the point cloud characteristic information provided in this disclosure may refer to the point cloud density, point cloud space occupation ratio, resolution, and number of point cloud points of the whole-level point cloud; and the point cloud characteristic information may alternatively refer to the point cloud density, point cloud space occupation ratio, resolution, and number of point cloud points of the slice-level point cloud.

In an embodiment, the bounding box information refers to a feature of a bounding box of the target point cloud.

The encoder performs coordinate transform on the geometry information of the target point cloud in a preprocessing stage, and in some examples, the point cloud may be all included in one bounding box. Referring to FIG. 5, the bounding box is defined as a minimum cuboid that includes all points in an input point cloud. An embodiment of determining an origin and a size of the bounding box is as follows:

A coordinate of a floating point type of a k^{th} point of the input point cloud is expressed as (xₖ, yₖ, zₖ), k=0, . . . , K−1, and K is a number of points in the point cloud, and coordinate information xₘᵢₙ, yₘᵢₙ, zₘᵢₙ, xₘₐₓ, yₘₐₓ, and zₘₐₓ are expressed as follows, respectively:

$${x}_{min =} min ( {x}_{0} , {x}_{1} , … , {x}_{K - 1} )$$

$${y}_{min =} min ( {y}_{0} , {y}_{1} , … , {y}_{K - 1} )$$

$${z}_{min =} min ( {z}_{0} , {z}_{1} , … , {z}_{K - 1} )$$

$${x}_{max =} max ( {x}_{0} , {x}_{1} , … , {x}_{K - 1} )$$

$${y}_{max =} max ( {y}_{0} , {y}_{1} , … , {y}_{K - 1} )$$

$${z}_{max =} max ( {z}_{0} , {z}_{1} , … , {z}_{K - 1} )$$

The function min(s₀, s₁, . . . , s_{K-1}) represents taking a minimum value of a current input (s₀, s₁, . . . , s_{K-1}), and max (s₀s₁, . . . , s_{K-1}) represents taking a maximum value in the current input (s₀, s₁, . . . , s_{K-1}).

Further, an embodiment of determining the origin (x_{origin}, y_{origin}, z_{origin}) of the bounding box is as follows:

$${x}_{origin =} int ( floor ( {x}_{min} ) )$$

$${y}_{origin =} int ( floor ( {y}_{min} ) )$$

$${z}_{origin =} int ( floor ( {z}_{min} ) )$$

Sizes of the bounding box in a direction x, a direction y, and a direction z may be calculated as follows:

$$Bounding\_Box \_Size {\_x}_{=} = int ( {x}_{max} - {x}_{origin} ) + 1 ,$$

$$Bounding\_Box \_Size \_y = int ( {y}_{max} - {y}_{origin} ) + 1 ,$$

$$Bounding\_Box \_Size \_z = int ( {z}_{max} - {z}_{origin} ) + 1 ,$$

where int(s) denotes a rounding function, and the function floor(s) returns a maximum integer value less than or equal to s.

In this disclosure, the bounding box information of the target point cloud may include one or more of the following information: lengths and directions of three sides of the bounding box, and statistical values about lengths of the three sides of the bounding box. The statistical values about the lengths of the three sides of the bounding box include one or more of the following information: an average length value of the three sides, a medium length value of the three sides, a mode length value of the three sides, a maximum length value of the three sides, a minimum length value of the three sides, a linear combination of lengths of at least two sides, calculation related to a volume of the bounding box, calculation related to a surface area of the bounding box, and the like.

For example, the linear combination of the lengths of the at least two sides may include: a sum of the side lengths, a difference between the side lengths, a combination of logarithms corresponding to the side lengths, and the like.

For example, calculation related to the surface area of the bounding box may include information such as a surface area corresponding to a shortest side, surface areas corresponding to two longer sides, a combination of the foregoing different types of surface areas, or a combination of logarithms of the foregoing different types of surface areas.

Any statistical value determined based on the bounding box information may be considered as the target feature.

After the foregoing embodiment describes an embodiment of acquiring the target feature, how the decoder determines the grouping information based on the foregoing target feature is described below.

In this disclosure, a specific mode for determining the grouping information based on the target feature of the target point cloud through the decoder is not limited.

In some embodiments, the decoder may determine at least one of the point cloud characteristic information of the target point cloud, the bounding box information, the coding parameter information, or the target parameter information as the grouping information.

In some embodiments, the decoder may determine the grouping information through the following operation S410-1, operation S410-2A, or operation S410-2B:

S410-1: Map at least one of the target features by using a target function, to obtain at least one mapping value. In some examples, at least one type of information of the target feature is mapped, by using one or more target functions, to obtain one or more mapping values.

For example, the decoder maps a target feature x by using a target function f( ), to obtain a mapping value f(x) corresponding to the target feature.

In this disclosure, the target function f( ) may be a linear function, a quadratic function, a direct proportion function, an inverse proportion function, a trigonometric function, an exponential function, a logarithmic function, and the like. For example, the target function is a logarithmic function f(x)=log₂x.

In this disclosure, when the target feature is represented as a parameter value or a feature value, the decoder may perform mapping processing on the value by using the target function. For example, when the target feature includes two or more parameter values, the decoder may map different parameter values by using different types of target functions. For example, when the target feature includes parameter values x1 and x2, obtained corresponding mapping values may be: lg(x1) and e^{x2}.

For example, the mapping processing may alternatively be a linear combination related to the number of points, such as Log₂(a*num_points+/−b), where a and b are constants; or the mapping processing may be a linear combination related to a logarithmic value of the number of points, such as b−a*Log₂(num_points) or b+a*Log₂(num_points), where a and b are constants.

The mapping value may alternatively be a parameter value of the target feature. For example, the parameter value of the target feature is x3, and after the mapping processing in one or more embodiments, the mapping value is still x3.

In some embodiments, in this disclosure, after mapping the target feature based on the foregoing target function, the decoder determines that the mapping value is an integer. In at least one aspect, rounding calculation is performed after a logarithmic operation when the target function includes the logarithmic operation; and the rounding calculation is performed after a division operation when the target function includes the division operation. In a case where a decimal occurs in a mapping process based on another target function, or in a case where the target feature is still the target feature itself after mapping by using the target function, and the target feature includes a decimal, a rounding operation further needs to be performed.

In an embodiment, the rounding calculation may be: rounding up, rounding down, rounding to a nearest integer, or the like. Certainly, other forms of rounding calculation modes, such as rounding half to even, may alternatively be adopted, which are not limited in this disclosure. For example, if the target feature is the number of points of the target point cloud with a value of 10,000, and the target function is a logarithmic function with base 2, the mapping value determined by using the target function is: round(log₂(10000)).

After the mapping value is determined, the following operation S410-2A or operation S410-2B may be performed to determine the grouping information.

S410-2A: Determine the grouping information based on a combination of at least one mapping value or a combination of a mapping value and a constant. For example, the grouping information is determined based on a combination of the one or more mapping values and a constant.

The combination may be a linear combination or a nonlinear combination.

In at least one embodiment, assuming that the at least one mapping value may be denoted as f(x) and g(y), the grouping information may be denoted as: A×f(x)+B×g(y), A×f(x)−B×g(y), A×f(x)²+A×g(y)², A×f(x)²−A×g(y)², A×f(x)³+B×g(y), and the like. f( ) and go may denote two identical or different target functions, and A and B are constants and positive numbers.

S410-2B: Determine the grouping information based on a combination of the at least one mapping value and an unmapped target feature. For example, the grouping information is determined based on a combination of the one or more mapping values and an unmapped type of information of the target feature.

As described above, the unmapped target feature may further be considered as the case in which the unmapped target feature is still the target feature after being mapped by the target function. Assuming that a mapping value corresponding to x is still x, the at least one mapping value obtained by mapping the at least one target feature by using the target function may be denoted as g(y), and the grouping information may be denoted as C×x+B×g(y), C×x−B×g(y), C×x²+A×g (y)², C×x²−A×g (y)², C×x³+B×g(y), and the like. f( ) and go may denote two identical or different target functions, and A, B, and C are constants and positive numbers.

In an embodiment, the grouping information may include an initial grouping step size, or may include an intermediate value for calculating the initial grouping step size, or may include an upper limit value and/or a lower limit value of the initial grouping step size. Therefore, in at least one aspect, an implementation of S410 may include any one or more of the following operations S410-A to S410-C:

S410-A: Determine an initial grouping step size in the grouping information.

S410-B: Determine an intermediate value for calculating the initial grouping step size, and determine the initial grouping step size based on the intermediate value, and obtain the grouping information.

S410-C: Determine an upper limit value and/or a lower limit value of the initial grouping step size in the grouping information, and determine an upper limit value and/or a lower limit value of the intermediate value of the grouping information.

The initial grouping step size refers to a step size employed by the decoder to perform initial grouping on first reconstructed position points (i.e., the reconstructed position points obtained by decoding the geometry bitstream on the decoder side) after reordering the reconstructed position points. To be specific, the initial grouping step size is a grouping step size in a case where the grouping step size is not updated. To be specific, the initial grouping step size is a step size employed by the decoder to perform grouping on the reconstructed position points for the first time during the attribute reconstruction process of the target point cloud.

The following describes an implementation of S410-A, namely, an implementation of determining the initial grouping step size L_{b}.

Implementation example 1:

$${L}_{1} = {Log}_{s} ( gsh\_bounding \_box \_size \_x ) + {Log}_{s} ( gsh\_bounding \_box \_size \_y ) + {Log}_{s} ( gsh\_bounding \_box \_size \_z ) ;$$

$${L}_{2} = {Log}_{s} ( slice\_num \_points ) ;$$

$${L}_{b} = {L}_{1} - {L}_{2} , and {L}_{b} \geq 1 ,$$

where Logₛ( ) denotes ceilLogₛ( ), floorLogₛ( ) or roundLogₛ( ); and
L_{b} denotes the initial grouping step size, gsh_bounding_box_size denotes a bounding box size of a slice-level point cloud, slice_num_points denotes the number of points of the slice-level point cloud, s denotes a constant greater than 1, and L1 and L₂ denote an intermediate value, respectively.

Implementation example 2:

$${L}_{1} = {Log}_{s} ( bounding\_box \_size \_x ) + {Log}_{s} ( bounding\_box \_size \_y ) + {Log}_{s} ( bounding\_box \_size \_z ) ;$$

$${L}_{b} = max ( 3 , 3 \times round ( L 1 / 3 ) ) ,$$

where Logₛ( ) denotes ceilLogₛ( ), floorLogₛ( ) or roundLogₛ( ); and
L_{b} denotes an initial grouping step size, bounding_box_size_x, bounding_box_size_y, and bounding_box_size_z denote lengths of three sides of a bounding box of a target point cloud, respectively, s denotes a constant greater than 1, and L1 denotes an intermediate value.

Implementation example 3:

$${L}_{1} = 2 \times {Log}_{s} ( gsh\_bounding \_box \_size \_x ) ;$$

$${L}_{2} = {Log}_{s} ( slice\_num \_points ) ;$$

$${L}_{b} = {L}_{1} - {L}_{2} + shift ; and {L}_{b} \geq 1 ;$$

$$another expression is : {L}_{b} = max ( 1 , L 1 - L 2 + shift ) ;$$

$$or$$

$${L}_{b} = max ( 1 , L 1 - L 2 ) + shift ,$$

where Logₛ( ) denotes ceilLogₛ( ), floorLogₛ( ) or roundLogₛ( ); and
L_{b} denotes an initial grouping step size, gsh_bounding_box_size_x denotes a maximum length value of the three sides of a point cloud slice, slice_num_points denotes a number of points in the point cloud slice, shift denotes an offset value, s denotes a constant greater than 1, and L1 and L₂ denote an intermediate value, respectively.

Implementation example 4:

$${L}_{1} = {Log}_{s} ( bounding\_box \_size \_x ) + {Log}_{s} ( bounding\_box \_size \_y ) + {Log}_{s} ( bounding\_box \_size \_z ) ;$$

$${L}_{b} = max ( 3 , 3 \times round ( L 1 / 3 ) ) ,$$

where Logₛ( ) denotes ceilLogₛ( ), floorLogₛ( ), or roundLogₛ( ); and
L_{b} denotes an initial grouping step size, bounding_box_size_x, bounding_box_size_y, and bounding_box_size_z denote lengths of three sides of a bounding box of a target point cloud, respectively, s denotes a constant greater than 1, and L1 denotes an intermediate value.

Implementation example 5: In this embodiment, L_{b} is determined based on surface area information of the bounding box;

$${L}_{1} = gsh\_bounding \_box \_size \_x {\_log}_{2} + gsh\_bounding \_box \_size \_z {\_log}_{2} ; or$$

$${L}_{1} = ceil {Log}_{2} ( gsh\_bounding \_box \_size \_x * gsh\_bounding \_box \_size \_z ) ;$$

$${L}_{2} = ceil {log}_{2} ( num\_points ) ,$$

where x and z denote side lengths of a face with a minimum area among the six faces of the bounding box; or x and z denote the side lengths of the face with a maximum area among the six faces of the bounding box; or one of x and z denotes the length of the shortest side among the three sides of the bounding box; or one of x and z denotes the length of the longest side among the three sides of the bounding box; and

$${L}_{b} = max ( 1 , max ( 3 , 3 \times round ( L 1 - L 2 / 3 ) ) + shift ) .$$

Implementation example 6: In this embodiment, L_{b} is determined based on all or some of surface area information of a bounding box;

$${L}_{1} = ceil {Log}_{2} ( gsh\_bounding \_box \_size \_x * gsh\_bounding \_box \_size \_z + gsh\_bounding \_box \_size \_y * gsh\_boundingbox \_size \_z ) ;$$

$${L}_{2} = ceil {og}_{2} ( num\_points ) ; and$$

$${L}_{b} = max ( 3 , 3 \times round ( L 1 - L 2 / 3 ) ) + shift .$$

It can be seen from the foregoing several examples that, the decoder may determine the initial grouping step size L_{b} in the grouping information based on the bounding box information of the target point cloud. In at least one aspect, the decoder determines intermediate values L1 and L₂ for calculating the initial grouping step size based on the bounding box information of the target point cloud, and then calculates the initial grouping step size L_{b} in the grouping information based on the intermediate values L₁ and L₂.

Implementation example 7:

L₁ is obtained by parsing a bitstream; and the decoder parses the bitstream to obtain a fixed value about the initial grouping step size, and uses the fixed value as L₁; and

$${L}_{b} = {L}_{1} + shift .$$

Implementation example 8:

$${L}_{1} = 32 ;$$

$${L}_{2} = {log}_{2} ( num\_points ) ; and$$

$${L}_{b} = max ( 3 , 3 \times round ( L 1 - L 2 / 3 ) ) + shift .$$

Implementation example 9:

$${L}_{1} = min ( A , ceil {log}_{2} ( xyz ) ) ;$$

$${L}_{2} = {log}_{2} ( num\_points ) ; and$$

$${L}_{b} = max ( 3 , 3 \times round ( L 1 - L 2 / 3 ) ) + shift ,$$

where A denotes the fixed value in the target parameter information, and xyz denotes a volume of the bounding box.

In any implementation example, after the intermediate values L₁ and L₂ are determined, the initial grouping step size L_{b} may be determined in the following mode:

$${L}_{b} = max ( 3 , 3 \times round ( L 1 - L 2 / 3 ) ) + shift ; or$$

$${L}_{b} = max ( 3 , 3 \times round ( L 1 - L 2 / 3 ) + shift ) ; or$$

$${L}_{b} = max ( 1 , max ( 3 , 3 \times round ( L 1 - L 2 / 3 ) ) + shift ) .$$

A calculation mode for the shift in one or more implementation solutions may be any one of the following modes:

(1) The decoder obtains the shift based on a preset lookup table T. For example, an index value of the lookup table is calculated based on a geometry quantization parameter, an attribute quantization parameter, and a quantization offset parameter, and then a value of the shift is determined in the lookup table T based on the determined index value.

(2) The decoder determines the offset value based on an attribute feature obtained by parsing the bitstream of the target point cloud, such as a header information parameter attrQuantParam and a possible QPOffset.

(3) The decoder may further directly acquire a fixed value of the shift, and determine the fixed value as the value of the shift. The directly acquired fixed value may be a default value on the encoder/decoder side, or may be obtained by decoding through the decoder.

(4) The decoder may further determine a fixed value corresponding to the preset identifier as the offset value shift, where different preset identifiers correspond to different fixed values. For example, when the preset identifier is C1, the offset value is c1, when the preset identifier is C2, the offset value is c2, and both c1 and c2 are positive numbers. The preset identifier may be defaulted on the encoder/decoder side, or may be obtained by decoding through the decoder, or may be determined by the lookup table.

Implementation example 10:

In this embodiment, a value of the initial grouping step size in the grouping information is an integer multiple of a target fixed value, for example, ‘L₁’ in the foregoing “implementation example 8” is 32, where the value of L₁ is an integer multiple of 1, and in one or more embodiments, the “target fixed value” is 1. In this disclosure, the target fixed value may be determined by the decoder based on the target feature of the target point cloud; or the target fixed value may be determined by the decoder based on the preset identifier, and different preset identifiers correspond to different fixed values, s₀ that the target fixed value may be determined based on the preset identifier; or the target fixed value may be a first default value determined by the decoder in the target parameter information.

In some embodiments, as an implementation, S410 may include the following operation S1 to operation S2:

S1: Determine a target fixed value based on at least one of point cloud characteristic information, bounding box information, or coding parameter information in the target feature; or determine the target fixed value based on a preset identifier in the target parameter information, where different preset identifiers correspond to different fixed values; or determine a first default value in the target parameter information as the target fixed value.

S2: Determine an integer multiple of the target fixed value as a value of the initial grouping step size.

In some embodiments, the target feature used in S1 may be a default fixed parameter on an encoder/decoder side, or may be one or more of the foregoing coding parameter information, point cloud characteristic information, and bounding box information.

For example, when the target feature employs a point cloud type in the point cloud characteristic information, a value of the target fixed value is determined as m when the point cloud type is a dense type or a human eye vision type of the point cloud; or when the type of the point cloud is a sparse type or a machine vision type of the point cloud, the target fixed value is determined as n, where values of both m and n are positive integers.

For example, the value of m is 3, and the value of n is 1. For example, if the target feature is of the point cloud type and the point cloud type is the dense type, a value of the initial grouping step size may be an integer multiple of 3. Values of m and n are not limited in this disclosure.

For example, when the target feature employs the bounding box information, the target fixed value is determined as p when correlation among three sides of the bounding box satisfies a preset condition; or the target fixed value is determined as q when the correlation among the three sides of the bounding box does not satisfy a preset condition, where values of p and q are positive integers. The preset condition may be whether the correlation is greater than a preset value (such as 80%). In at least one aspect, the correlation among the lengths of the three sides may be determined by using a variance or a standard deviation of the lengths of the three sides. For example, if boundingbox_size_z is far less than or far greater than boundingbox_size_x or boundingbox_size_y, a length similarity of the three sides of the bounding box is relatively small.

For example, a value of p is 3, and a value of q is 1. For example, if the variance among boundingbox_size_z, boundingbox_size_x, and boundingbox_size_y is less than a preset value, the length similarity of the three sides of the bounding box is high, and the value of the initial grouping step size may be an integer multiple of 3. Values of p and q are not limited in this disclosure.

For example, the target fixed value may further be determined based on the coding parameter information, for example, determined based on a geometry quantization parameter and/or an attribute quantization parameter.

In some other embodiments, the preset identifier in S1 may be defaulted by the encoder/decoder side, or may be obtained by decoding, or may be determined based on a preset lookup table. For example, when the decoder determines that the identifier is Q1, a fixed value corresponding to the identifier Q1 is determined as the target fixed value. In addition, the decoder may further directly acquire the first default value, and determine the first default value as the target fixed value. The first default value may be defaulted by the encoder/decoder side, or may be obtained by decoding through the decoder.

An implementation for determining the initial grouping step size is not limited to the foregoing embodiments. For example, the initial grouping step size may alternatively be another combination of the target features and another combination of the target feature and constants. This is not limited in this disclosure.

The following describes an implementation of S410-B, i.e., an implementation of calculating an intermediate value of the initial grouping step size L_{b}:

In some applications, when an attribute is reflectivity, in an attribute reconstruction process, an expression formula of the initial grouping step size is as follows:

$${L}_{b a s e} = max ( 3 , 3 * ( \frac{max Bits - min Bits}{3} ) ) + shift$$

The intermediate value for determining the initial grouping step size L_{base} is the offset value shift, or may be a maximum number of bits maxBits and a minimum number of bits minBits.

One or more embodiments of this disclosure may be implemented based on the embodiment corresponding to S410-A. The decoder may directly determine the initial grouping step size L_{b} based on the target feature, or may determine the intermediate value of the initial grouping step size L_{base} in some applications based on foregoing target feature. The decoder may further determine a second default value in the target parameter information as an intermediate value. The second default value may be defaulted by the encoder/decoder side, or may be obtained by decoding through the decoder, or may be determined based on a preset lookup table. The decoder may further determine a fixed value corresponding to a preset identifier in the target parameter information as the intermediate value, where different preset identifiers correspond to different fixed values.

For example, the maximum number of bits maxbits is Logₛ(V(bounding_box)); the minimum number of bits minbits is ceilLogs (A), where maxbits denotes the maximum number of bits, V(bounding_box) denotes a volume of the bounding box, minbits denotes the minimum number of bits, and A denotes a fixed parameter.

For example, the maximum number of bits maxbits is Logₛ(num_points); a value of the minimum number of bits minbits varies based on the type of the target point cloud. Num_points denotes the number of points in the target point cloud.

For example, the offset value shift may be determined based on the attribute feature obtained by parsing the bitstream of the target point cloud, such as the header information parameter attrQuantParam and the possible QPOffset.

For example, the offset value may further be determined based on a fixed parameter X1 determined by looking up a preset table, where the preset table is generated before or when the encoder encodes the target point cloud.

For example, the offset value shift may be determined based on a fixed parameter X2 obtained by parsing the bitstream of the target point cloud. For example, shift=ceil(log₂(X2)).

It can be learned that, in this disclosure, various combinations of the target features and the mapping values thereof may be determined through operation S420-2A or operation S420-2B, thereby providing multiple modes for determining the intermediate value. An combination mode is not limited in this disclosure.

An implementation of S410-C, namely, determining an upper limit value or a lower limit value of the intermediate value or the initial grouping step size L_{b} includes, but is not limited to the following modes:

(1) The decoder determines an obtained third default value as an upper limit value of the intermediate value (such as shift, maxbits, or minbits), and determines an obtained fourth default value as a lower limit value of the intermediate value (such as shift, maxbits, or minbits). For example, the decoder uses a fixed value a as an upper limit value of the intermediate value shift, and uses a fixed value b as an upper limit value of shift. Values of a and b are positive numbers, and a is greater than b. For example, the fixed value a and the fixed value b may be defaulted by the encoder/decoder side, or may be directly obtained by decoding a bitstream through the decoder. In another embodiment, the decoder may determine the fixed value a based on a first preset identifier, and determine the fixed value b based on a second preset identifier, where the first preset identifier indicates that the upper limit value of shift is set to the corresponding fixed value a, and the second preset identifier indicates that the lower limit value of shift is set to the corresponding fixed value b. The first preset identifier and the second preset identifier may be defaulted by the encoder/decoder side, or may be directly obtained by decoding the bitstream through the decoder.

Similarly, the decoder may further use a fixed value a′ as the upper limit value of the initial grouping step size L_{b}, and uses a fixed value b′ as the upper limit value of the initial grouping step size L_{b}. Values of a′ and b′ are positive numbers, and a′ is greater than b′. For example, the fixed value a′ and the fixed value b′ may be defaulted by the encoder/decoder side, or may be directly obtained by decoding a bitstream through the decoder. In another embodiment, the decoder may determine the fixed value a′ based on a first preset identifier, and determine the fixed value b′ based on a second preset identifier, where the first preset identifier indicates that the upper limit value of L_{b} is set to the corresponding fixed value a′, and the second preset identifier indicates that the lower limit value of L_{b} is set to the corresponding fixed value b′. The first preset identifier and the second preset identifier may be defaulted by the encoder/decoder side, or may be directly obtained by decoding the bitstream through the decoder.

(2) The decoder may determine the upper limit value and the lower limit value of the initial grouping step size L_{b} or the intermediate value based on the point cloud type. For example, compared with the point cloud of the sparse type, the upper limit value and the lower limit value of the initial grouping step size L_{b} of the point cloud of the dense type are both relatively small. For example, for the dense-type point cloud, the upper limit value of the initial grouping step size L_{b} is z1 and the lower limit value is z2; for a sparse-type point cloud, the upper limit value of the initial grouping step size L_{b} is z3 and the lower limit value is z4; and a value of z1 is less than z3, and the value of z2 is less than z4.

(3) The decoder may determine the upper limit value and the lower limit value of the initial grouping step size L_{b} or the intermediate value based on the coding parameter information; for example, the upper limit value and the lower limit value of L_{b} are determined based on a geometry output bit depth, an attribute output bit depth, a geometry quantization parameter, and an attribute quantization parameter; for example, the upper limit value and the lower limit value of L_{b} may further be determined based on a transform method, a prediction method, and an ordering method; if the transform method is predicting transform encoding, the upper limit value of the initial grouping step size L_{b} is determined as s1, the lower limit value is s2, and s1 is greater than s2; if the transform method is lifting transform encoding, the upper limit value of the initial grouping step size L_{b} is determined as s3, the lower limit value is determined as s4, and s3 is greater than s4; and s1 and s3 may be different positive numbers, and s2 and s4 may further be different positive numbers.

(4) The decoder may determine the upper limit value and the lower limit value of the initial grouping step size L_{b} or the intermediate value based on the bounding box parameter information such as side lengths of a bounding box, and correlation of the side length.

The implementation example for determining the upper limit value and the lower limit value of the initial grouping step size L_{b} is not limited to the aforementioned content and may be other forms based on the aforementioned target feature.

Still refer to FIG. 4. S420: Group first reconstructed position points based on the grouping information to obtain a plurality of groups, where the first reconstructed position points are obtained by decoding a geometry bitstream of the target point cloud through a decoder. In some examples, reconstructed position points are decoded, by processing circuitry, from a geometry bitstream of the target point cloud. In some examples, the reconstructed position points are grouped, by the processing circuitry, into a plurality of groups of position points based on the grouping information.

S430: Perform attribute decoding on each group. In some examples, attributes of each group of the plurality of groups of position points are decoded from an attribute bitstream of the target point cloud. In some examples, reconstructed points of the target point cloud are obtained based on the reconstructed position points and the decoded attributes.

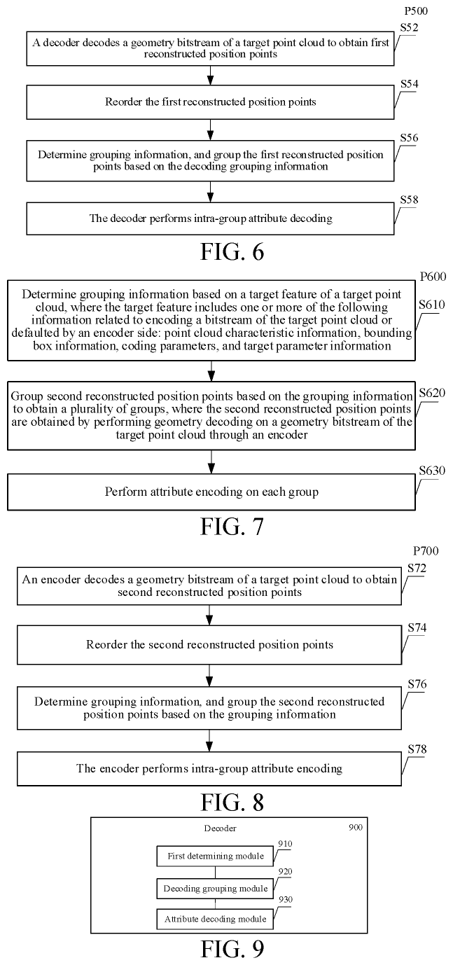

In an embodiment, the decoder determines the initial grouping step size in the grouping information according to the foregoing embodiment. The decoder groups the reordered reconstructed position points based on the initial grouping step size. An implementation of grouping is described in detail in an embodiment corresponding to FIG. 6. Further, the decoder performs attribute decoding based on the grouped reconstructed position points, thereby completing a process of decoding the bitstream of the target point cloud, to obtain a reconstructed point cloud of the target point cloud.

In the point cloud decoding solution P400 provided in this disclosure, the decoder determines the grouping information based on one or more of the following information defaulted by the encoder/decoder side or obtained by parsing the bitstream of the target point cloud: point cloud characteristic information, bounding box information, coding parameter information, and target parameter information. In an attribute decoding process, the decoder groups the first reconstructed position points based on the grouping information to obtain a plurality of groups. The first reconstructed position points are obtained by decoding the geometry bitstream of the target point cloud through the decoder. Further, the decoder performs attribute decoding on each group. In the decoding solution provided in this disclosure, the decoder determines the grouping information based on the target feature. The grouping information is, for example, the initial grouping step size, the intermediate value for determining the initial grouping step size, and the upper limit value and lower limit value of the initial grouping step size. In this disclosure, the grouping information is determined based on the diversified feature related to the target point cloud. Compared to the mode for determining the initial grouping step size provided in some applications, this disclosure can enhance grouping diversity, thereby improving the decoding performance of the point cloud.

FIG. 6 is a schematic flowchart of a point cloud decoding method P500 according to another embodiment of this disclosure. The point cloud decoding method P500 may be performed by a decoder, or may be performed by an electronic device executing a decoding process. Refer to FIG. 5. The point cloud decoding method P500 includes operation S52 to operation S58.

S52: A decoder decodes a geometry bitstream of a target point cloud to obtain first reconstructed position points.

For example, the reconstructed position points obtained by decoding the geometry bitstream through a decoder side are written as the first reconstructed position points. Furthermore, a reconstructed position point obtained by an encoder side in an attribute prediction stage is written as a second reconstructed position point.

In this disclosure, a reconstruction order of a point cloud geometry coordinate includes, but is not limited to the following modes:

(a) After the slice geometry information is decoded and reconstructed as xyz, the decoder performs an overall reconstruction on the geometry information of the current slice, namely, the final reconstructed geometry information is: rec_xyz=xyz+gsh_bounding_box_offset. Gsh_bounding_box_offset denotes a coordinate of an origin xyz of a slice bounding box.

(b) After the slice attribute information is decoded and reconstructed, the decoder performs overall reconstruction on geometry information of the current slice.

S54: The decoder reorders the first reconstructed position points.

A mode of reordering the first reconstructed position points is not limited in this disclosure. For example, the decoder may perform reordering based on an input order of the point cloud; or the decoder may perform reordering based on an order of a point cloud space curve (including a Morton order and a Hilbert order); or the decoder may perform reordering based on information (such as collection information and Lidar information) about input parameters, and the like.

S56: The decoder determines the grouping information and groups the first reconstructed position points based on the grouping information.

An implementation in which the decoder determines the grouping information is described in detail in the embodiment corresponding to P400, and details are not described herein again.

In this disclosure, for example, the first reconstructed position points are re-ordered based on the Hilbert order, and the re-ordered points correspond to Hilbert codes. In a case where the grouping information determined in the foregoing embodiment is an initial grouping step size L_{b}, the Hilbert codes corresponding to the first reconstructed position points may be grouped in the following mode:
(1) Based on the determined initial grouping step size L_{b}, the decoder performs initial grouping on the first reconstructed position points; and
points with identical values after right-shifting the Hilbert codes by the initial grouping step size L_{b} are assigned to a same macroblock.
(2) The decoder determines whether the Hilbert codes in the same macroblock need to be sub-grouped; and

for the points in each macroblock, the decoder may determine whether there is a repeated point in the current macroblock. If there is the repeated point in the current macroblock, grouping is truncated at the repeated point, and the repeated points are independently grouped, namely, the repeated points are grouped based on a point number of 1. Assuming that the current macroblock includes four points, and the fourth point is a repeated point, the first three points may be grouped together, and the fourth repeated point is placed in a separate group.

In some applications, in a color reconstruction process, if the number of points in a current block is less than or equal to a maximum transform order colorMaxTransNum, the points in the macroblock are grouped together; and if the number of points in the current block is greater than colorMaxTransNum, the points in the block are sub-grouped. A sub-grouping rule is: a current right-shifting number L is acquired, a value of a right-shifting number L1 of the current sub-grouping is L−1, and the identical points after right-shifting the Hilbert code by L1 bits are assigned into a new sub-group; and whether the number of points in the sub-group is greater than colorMaxTransNum is further determined until the number of points in each sub-group is less than or equal to colorMaxTransNum.

In some applications, in a reflectivity reconstruction process, if the number of points in the current macroblock is greater than a maximum transform order reflMaxTransNum, the decoder sequentially selects points of the maximum transform order reflMaxTransNum as one sub-group until the number of points in each group in the macroblock is less than or equal to reflMaxTransNum.

In this disclosure, a method provided in some applications may be employed to determine whether the points in the macroblock need to be sub-grouped.

(3) The decoder determines whether a grouping step size needs to be updated.

In some applications, in a color reconstruction process, statistics is performed on a sum of numbers of points in first three consecutive groups, and the sum is right-shifted by three bits (namely, divided by 8), to be written as B. If a value of B is less than 2, an updated step size L is equal to L+1; if the value of B is greater than 8, the updated step size L is equal to L−1; and If B is greater than or equal to 2 and less than or equal to 8, the step size L is not updated.

In some applications, in the reflectivity reconstruction process, if the maximum transform order reflMaxTransNum is greater than 2 and an offset value shift in the initial grouping step size is greater than 0, the decoder updates the grouping step size; and otherwise, the current grouping step size remains unchanged. In at least one aspect, the decoder performs statistics on a total number of points in first N groups, and calculates an average number of points in the N (for example, N is equal to 8) groups, and if the average number of points is less than 2, the updated grouping step size L is equal to L+1; if the average number of points is greater than the maximum transform order reflMaxTransNum, an updated grouping step size is equal to L−1; and if the average number of points is greater than or equal to 2 and less than or equal to the maximum transform order reflMaxTransNum, the grouping step size L further remains unchanged.

It can be learned that, in some applications, the numbers of points in first multiple groups are considered when determining whether to update the grouping step size. In some applications, the sub-group of one point formed by the repeated points may further be taken as the first group and employed to determine whether to update the grouping step size, namely, the number of points in the group formed by the repeated points is considered in some applications.

In this disclosure, a method for sub-grouping the points in the current macroblock includes but is not limited to the following:

(a) The decoder performs statistics on numbers of points corresponding to first N groups that are directly grouped based on grouping step size information, where the direct grouping is sub-grouping, i.e., grouping determined based on the grouping step size. In at least one aspect, whether to update the grouping step size is determined based on the number of points.

(b) The decoder performs statistics on the numbers of points corresponding to the first N groups that do not include the repeated points. This method differs from the method in some other applications in which when determining whether to update the grouping step size requires the statistics of the number of repeated points. In this disclosure, whether the grouping step size needs to be updated is determined by performing statistics on the number of points in a group that does not include the repeated points.

In this disclosure, a grouping step size updating mode is more flexible, which is conducive to improving decoding performance.

Further refer to FIG. 6. S58: The decoder performs intra-group attribute decoding.

In an embodiment, after all the first reconstructed position points are grouped, an attribute encoding process may be performed on each group obtained by grouping. In another embodiment, after the sub-groups of each macroblock are determined, an attribute encoding process may be performed on the completed groups of the current macroblock while a next macroblock is processed, thereby improving overall encoding efficiency.

In the point cloud decoding solution P500 provided in this disclosure, which is the same as in the method P400, the decoder determines the grouping information based on one or more of the following information defaulted by an encoder/decoder side or obtained by parsing the bitstream of the target point cloud: point cloud characteristic information, bounding box information, coding parameter information, and target parameter information. Furthermore, compared with some other applications, the point cloud decoding method P500 provided in one or more embodiments not only improves a mode of determining an initial grouping step size and an intermediate value of the initial grouping step size to diversify the grouping, but also extends a mode of determining whether to update the grouping step size to provide an optimized processing solution for the attribute decoding process, and extends a geometry reconstruction mode. The improvements are conducive to improving the decoding performance of the point cloud.

The point cloud encoding method provided in this disclosure is described in detail above with reference to some embodiments. The point cloud encoding method provided in this disclosure is described in detail below with reference to some embodiments.

FIG. 7 is a schematic flowchart of a point cloud encoding method P600 according to an embodiment of this disclosure. The point cloud encoding method P600 may be performed by an encoder, or may be performed by an electronic device (such as an encoder) executing an encoding process. Refer to FIG. 7. The point cloud encoding method P600 includes operation S610 to operation S630.

S610: Determine grouping information based on a target feature of a target point cloud, the target feature including one or more of the following information related to encoding a bitstream of a target point cloud or defaulted by an encoder side: point cloud characteristic information, bounding box information, coding parameter information, and target parameter information. In some examples, grouping information is determined based on a target feature of a target point cloud, the grouping information including an initial grouping step size associated with the target feature, and the target feature including one or more types of information that include: point cloud characteristic information, bounding box information, coding parameter information, or target parameter information.

The target point cloud is any point cloud data, for example, may be point cloud data corresponding to a video frame.

Before an encoder preprocesses the target point cloud, whether a whole point cloud sequence is partitioned into a plurality of point cloud slices may be determined based on a parameter configuration. In a case where the whole point cloud sequence is determined to be partitioned into a plurality of point cloud slices based on the parameter configuration, each point cloud slice may be treated as a single independent point cloud for serial processing. Therefore, in some embodiments, the target point cloud may be a whole-level point cloud. In some embodiments, the target point cloud may alternatively be a point cloud slice obtained by partitioning the whole-level point cloud sequence, namely, the target point cloud may be a slice-level point cloud.

Similarly, the target feature may be a feature of a whole-level point cloud, or may be a feature of a slice-level point cloud. For example, if the target feature is a point cloud density, then if the target point cloud is the whole-level point cloud, the target feature refers to the density of the whole-level point cloud; if the target point cloud is the slice-level point cloud, the target feature refers to the density of a point cloud slice obtained by partitioning the whole-level point cloud.

In an embodiment of this disclosure, the encoder may determine the information required for encoding the target point cloud as the target feature, such as one or more of the following obtained information: point cloud characteristic information, bounding box information, coding parameter information, and target parameter information. In another embodiment of this disclosure, the target feature may alternatively be default information on the encoder/decoder side. In addition, the encoder may further look up a preset table to determine the target feature, where the preset table is generated before or when the target point cloud is encoded. Default parameters on the encoder/decoder side refer to information that is mutually defaulted by the encoder side and the corresponding decoder side, and refer to the information that does not need to be encoded/decoded in a point cloud encoding/decoding process. The target parameter information may include a constant value (or referred to as a fixed value or a default value), and may further include at least one preset identifier, where each preset identifier corresponds to a fixed value.

In an embodiment, the coding parameter information refers to a feature parameter employed when the target point cloud is encoded, and may include one or more of the following information: an attribute predictive transform maximum transform order, an attribute output bit depth, and an attribute quantization parameter required by the encoder to encode the attribute information; and a geometry output bit depth and a geometry quantization parameter required by the encoder to encode the geometry information. The coding parameter information may further include: a transform method, a prediction method, an ordering method, and the like.

In an embodiment, the point cloud characteristic information may reflect a characteristic of the target point cloud, for example, may include one or more of the following information: a point cloud type, a point cloud density, a point cloud space occupation ratio, a resolution, and a number of point cloud points.

The point cloud characteristic information provided in this disclosure may refer to the point cloud density, point cloud space occupation ratio, resolution, and number of point cloud points of the whole-level point cloud; and the point cloud characteristic information may alternatively refer to the point cloud density, point cloud space occupation ratio, resolution, and number of point cloud points of the slice-level point cloud.

In an embodiment, the bounding box information refers to a feature of a bounding box of the target point cloud.

The encoder performs coordinate transform on the geometry information of the target point cloud in a preprocessing stage, and in some examples, the point cloud may be all included in one bounding box. Referring to FIG. 5, the bounding box is defined as a minimum cuboid that includes all points in an input point cloud.

An embodiment of determining an origin and a size of the bounding box is as follows:
A coordinate of a floating point type of a k^{th} point of the input point cloud is expressed as (xₖ, yₖ, zₖ), k=0, . . . , K−1, and K is a number of points in the point cloud, and coordinate information xₘᵢₙ, yₘᵢₙ, zₘᵢₙ, xₘₐₓ, yₘₐₓ, and zₘₐₓ are expressed as follows, respectively:

$${x}_{min =} min ( {x}_{0} , {x}_{1} , … , {x}_{K - 1} )$$

$${y}_{min =} min ( {y}_{0} , {y}_{1} , … , {y}_{K - 1} )$$

$${z}_{min =} min ( {z}_{0} , {z}_{1} , … , {z}_{K - 1} )$$

$${x}_{max =} max ( {x}_{0} , {x}_{1} , … , {x}_{K - 1} )$$

$${y}_{max =} max ( {y}_{0} , {y}_{1} , … , {y}_{K - 1} )$$

$${z}_{max =} max ( {z}_{0} , {z}_{1} , … , {z}_{K - 1} )$$

The function min(s₀, s₁, . . . , s_{K-1}) represents taking a minimum value of a current input (s₀, s₁, . . . , s_{K-1}), and max(s₀s₁, . . . , s_{K-1}) represents taking a maximum value in the current input (s₀, s₁, . . . , s_{K-1}).

Further, an embodiment of determining the origin (x_{origin}, y_{origin}, z_{origin}) of the bounding box is as follows:

$${x}_{origin =} int ( floor ( {x}_{min} ) )$$

$${y}_{origin =} int ( floor ( {y}_{min} ) )$$

$${z}_{origin =} int ( floor ( {z}_{min} ) )$$

Sizes of the bounding box in a direction x, a direction y, and a direction z may be calculated as follows:

$$Bounding\_Box \_Size \_x = int ( {x}_{max} - {x}_{origin} ) + 1 ,$$

$$Bounding\_Box \_Size \_y = int ( {y}_{max} - {y}_{origin} ) + 1 ,$$

$$Bounding\_Box \_Size \_z = int ( {z}_{max} - {z}_{origin} ) + 1 ,$$

where int(s) denotes a rounding function, and the function floor(s) returns a maximum integer value less than or equal to s.

In one or more embodiments of this disclosure, the bounding box information of the target point cloud may include one or more of the following information: lengths and directions of three sides of the bounding box, and statistical values about lengths of the three sides of the bounding box. The statistical values about the lengths of the three sides of the bounding box include one or more of the following information: an average length value of the three sides, a medium length value of the three sides, a mode length value of the three sides, a maximum length value of the three sides, a minimum length value of the three sides, a linear combination of lengths of at least two sides, calculation related to a volume of the bounding box, calculation related to a surface area of the bounding box, and the like. For example, the linear combination of the lengths of the at least two sides may include: a sum of the side lengths, a difference between the side lengths, a combination of logarithms corresponding to the side lengths, and the like. Calculation related to the surface area of the bounding box may include information such as a surface area corresponding to a shortest side, surface areas corresponding to two longer sides, a combination of the foregoing different types of surface areas, or a combination of logarithms of the foregoing different types of surface areas. Any statistical value determined based on the bounding box information may be considered as the target feature.

After the foregoing embodiment describes an embodiment about the target feature, how to determine the grouping information based on the target feature is described below.

In one or more embodiments of this disclosure, a specific mode for determining the grouping information based on the target feature of the target point cloud through the encoder is not limited.

In some embodiments, the encoder may determine at least one of the point cloud characteristic information, bounding box information, coding parameter information, or target parameter information of the target point cloud as the grouping information.

In some embodiments, the encoder may determine the grouping information through the following operation S610-1, operation S610-2A, or operation S610-2B:

S610-1: Map at least one of the target features by using a target function, to obtain at least one mapping value. For example, at least one type of information of the target feature is mapped by using one or more target functions, to obtain one or more mapping values.

For example, the encoder maps a target feature x by using a target function f( ), to obtain a mapping value f(x) corresponding to the target feature.

In one or more embodiments of this disclosure, the target function f( ) may be a linear function, a quadratic function, a direct proportion function, an inverse proportion function, a trigonometric function, an exponential function, a logarithmic function, and the like. For example, the target function is a logarithmic function f(x)=log₂x.

In one or more embodiments of this disclosure, when the target feature is represented as a parameter value or a feature value, the encoder may perform mapping processing on the value by using the target function. For example, when the target feature includes two or more parameter values, the encoder may map different parameter values by using different types of target functions. For example, when the target feature includes parameter values x1 and x2, obtained corresponding mapping values may be: lg(x1) and e^{x2}.

For example, the mapping processing may alternatively be a linear combination related to the number of points, such as Log 2(a*num_points+/−b), where a and b are constants; or the mapping processing may be a linear combination related to a logarithmic value of the number of points, such as b−a*Log 2(num_points) or b+a*Log 2(num_points), where a and b are constants.

The mapping value may alternatively be a parameter value of the target feature. For example, the parameter value of the target feature is x3, and after the mapping processing in this embodiment, the mapping value is still x3.

In some embodiments, after mapping the target feature based on the target function, the encoder determines that the mapping value is an integer. In at least one aspect, rounding calculation is performed after a logarithmic operation when the target function includes the logarithmic operation; and the rounding calculation is performed after a division operation when the target function includes the division operation. In a case where a decimal occurs in a mapping process based on another target function, or in a case where the target feature is still the target feature itself after mapping by using the target function, and the target feature includes a decimal, a rounding operation further needs to be performed.

In an embodiment, the rounding calculation may be: rounding up, rounding down, rounding to a nearest integer, or the like. Certainly, other forms of rounding calculation modes, such as rounding half to even, may alternatively be adopted, which are not limited in this disclosure. For example, if the target feature is the number of points of the target point cloud with a value of 10,000, and the target function is a logarithmic function with base 2, the mapping value determined by using the target function is: round(log₂(10000)).

After the mapping value is determined, the following operation S610-2A or operation S610-2B may be performed to determine the grouping information.

S610-2A: Determine the grouping information based on a combination of at least one mapping value or a combination of the mapping value and a constant. For example, the grouping information is determined based on a combination of the one or more mapping values and a constant, a combination of the one or more mapping values.

The combination may be a linear combination or a nonlinear combination.

In an embodiment, assuming that the at least one mapping value may be denoted as f(x) and g(y), the grouping information may be denoted as: A×f(x)+B×g (y), A×f(x)−B×g(y), A×f(x)2+A×g (y)2, A×f(x)2−A×g (y)2, A×f(x) 3+B×g(y), and the like. f( ) and go may denote two identical or different target functions, and A and B are constants and positive numbers.

S610-2B: Determine the grouping information based on a combination of the at least one mapping value and an unmapped target feature. For example, the grouping information is determined based on a combination of the one or more mapping values and an unmapped type of information of the target feature.

As described above, the unmapped target feature may further be considered as the case in which the unmapped target feature is still the target feature after being mapped by the target function. Assuming that a mapping value corresponding to x is still x, the at least one mapping value obtained by mapping the at least one target feature by using the target function may be denoted as g(y), and grouping information may be denoted as C×x+B×g(y), C×x−B×g(y), C×x2+A×g (y)2, C×x 2−A×g (y)2, C×x 3+B×g(y), and the like. f( ) and go may denote two identical or different target functions, and A, B, and C are constants and integer numbers.

In an embodiment, the grouping information may include an initial grouping step size, or may include an intermediate value for calculating the initial grouping step size, or may include an upper limit value and/or a lower limit value of the initial grouping step size. Therefore, in at least one aspect, an implementation of S610 may include any one of the following operations:

S610-A: Determine an initial grouping step size in the grouping information.

S610-B: Determine an intermediate value for calculating the initial grouping step size, and determine the initial grouping step size based on the intermediate value, and obtain the grouping information.

S610-C: Determine an upper limit value and/or a lower limit value of the initial grouping step size in the grouping information, and determine an upper limit value and/or a lower limit value of the intermediate value of the grouping information.

The initial grouping step size represents a step size employed by the encoder to perform initial grouping on second reconstructed position points (reconstructed position points obtained by an encoder side in an attribute prediction stage) after reordering the reconstructed position points. To be specific, the initial grouping step size is a grouping step size in a case where the grouping step size is not updated. To be specific, the initial grouping step size is a step size employed by the encoder to perform grouping on the reconstructed position points for the first time during the attribute prediction process of the target point cloud.

The following describes an implementation of S610-A, namely, an implementation of determining the initial grouping step size L_{b} based on the target feature:

Implementation example 1:

$${L}_{1} = {Log}_{s} ( gsh\_bounding \_box \_size \_x ) + {Log}_{s} ( gsh\_bounding \_box \_size \_y ) + {Log}_{s} ( gsh\_bounding \_box \_size \_z ) ;$$

$${L}_{2} = {Log}_{s} ( slice\_num \_points ) ;$$

$${L}_{b} = {L}_{1} - {L}_{2} , and {L}_{b} \geq 1 ,$$

where Logₛ( ) denotes ceilLogₛ( ), floorLogₛ( ), or roundLogₛ( ); and
L_{b} denotes the initial grouping step size, gsh_bounding_box_size denotes a bounding box size of a slice-level point cloud, slice_num_points denotes the number of point cloud points of the point cloud slice level, s denotes a constant greater than 1, and L₁ and L₂ denote an intermediate value, respectively.

Implementation example 2:

$${L}_{1} = {Log}_{s} ( bounding\_box \_size \_x ) + {Log}_{s} ( bounding\_box \_size \_y ) + {Log}_{s} ( bounding\_box \_size \_z ) ;$$

$${L}_{b} = max ( 3 , 3 \times round ( L 1 / 3 ) ) ,$$

where Logₛ( ) denotes ceilLogₛ( ), floorLogₛ( ), or roundLogₛ( ); and
L_{b} denotes an initial grouping step size, bounding box_size x, bounding_box_size_y, and bounding_box_size_z denote lengths of three sides of a bounding box of the target point cloud, respectively, s denotes a constant greater than 1, and L₁ denotes an intermediate value.

Implementation example 3:

$${L}_{1} = 2 \times {Log}_{s} ( gsh\_bounding \_box \_size \_x ) ;$$

$${L}_{2} = {Log}_{s} ( slice\_num \_points ) ;$$

$$Lb = L 1 - L 2 + shift ; and Lb \geq 1 ;$$

$$another expression is : Lb = max ( 1 , L 1 - L 2 + shift ) ; or$$

$${L}_{b} = max ( 1 , L 1 - L 2 ) + shift ,$$

where Logₛ( ) denotes ceilLogₛ( ), floorLogₛ, or roundLogₛ( ); and
L_{b} denotes an initial grouping step size, gsh_bounding_box_size_x denotes a maximum length value of the three sides of a point cloud slice, slice_num_points denotes a number of points in the point cloud slice, shift denotes an offset value, s denotes a constant greater than 1, and L₁ and L₂ denote an intermediate value, respectively.

Implementation example 4:

$${L}_{1} = {Log}_{s} ( bounding\_box \_size \_x ) + {Log}_{s} ( bounding\_box \_size \_y ) + {Log}_{s} ( bounding\_box \_size \_z ) ;$$

$${L}_{b} = max ( 3 , 3 \times round ( L 1 / 3 ) ) ,$$

where Logₛ( ) denotes ceilLogₛ( ), floorLogₛ( ), or roundLogₛ( ); and
L_{b} denotes an initial grouping step size, bounding_box_size_x, bounding_box_size_y, and bounding_box_size_z denote lengths of three sides of a bounding box of the target point cloud, respectively, s denotes a constant greater than 1, and L₁ denotes an intermediate value.

Implementation example 5: In this embodiment, L_{b} is determined based on surface area information of the bounding box;

$${L}_{1} = gsh\_bounding \_box \_size \_x {\_log}_{2} + gsh\_bounding \_box \_size \_z {\_log}_{2}$$

$${L}_{1} = ceil {Log}_{2} ( gsh\_bounding \_box \_size \_x * gsh\_bounding \_box \_size \_z ) ; and$$

$${L}_{2} = ceil {log}_{2} ( num\_points ) ,$$

where x and z denote side lengths of a face with a minimum area among the six faces of the bounding box; or x and z denote the side lengths of the face with a maximum area among the six faces of the bounding box; or one of x and z denotes the length of the shortest side among the three sides of the bounding box; or one of x and z denotes the length of the longest side among the three sides of the bounding box; and

$${L}_{b} = max ( 1 , max ( 3 , 3 \times round ( L 1 - L 2 / 3 ) ) + shift ) .$$

Implementation example 6: In this embodiment, L_{b} is determined based on all or some of surface area information of a bounding box;

$${L}_{1} = ceil {Log}_{2} ( gsh\_bounding \_box \_size \_x * gsh\_boundingbox \_size \_z + gsh\_bounding \_box \_size \_y * gsh\_boundingbox \_size \_z ) ;$$

$${L}_{2} = ceil {og}_{2} ( num\_points ) ; and$$

$${L}_{b} = max ( 3 , 3 \times round ( L 1 - L 2 / 3 ) ) + shift .$$

It can be seen from the foregoing several examples that, the decoder may determine the initial grouping step size L_{b} in the grouping information based on the bounding box information of the target point cloud. In at least one aspect, the decoder determines intermediate values L₁ and L₂ for calculating the initial grouping step size based on the bounding box information of the target point cloud, and then calculates the initial grouping step size L_{b} in the grouping information based on the intermediate values L₁ and L₂.

Implementation example 7:
L₁ is obtained by parsing the bitstream; and the encoder determines a fixed value and uses the fixed value as L₁; and

$${L}_{b} = {L}_{1} + shift .$$

Implementation example 8:

$${L}_{1} = 32 ;$$

$${L}_{2} = {log}_{2} ( num\_points ) ; and$$

$${L}_{b} = max ( 3 , 3 \times round ( L 1 - L 2 / 3 ) ) + shift .$$

Implementation example 9:

$${L}_{1} = min ( A , ceil log ( xyz ) ) ;$$

$${L}_{2} = {log}_{2} ( num\_points ) ; and$$

$${L}_{b} = max ( 3 , 3 \times round ( L 1 - L 2 / 3 ) ) + shift ,$$

where A denotes the fixed value in the target parameter information, and xyz denotes a volume of the bounding box.

In any specific implementation, after the intermediate values L₁ and L₂ are determined, the initial grouping step size may be determined in the following mode:

$${L}_{b} = max ( 3 , 3 \times round ( L 1 - L 2 / 3 ) ) + shift ; or$$

$${L}_{b} = max ( 3 , 3 \times round ( L 1 - L 2 / 3 ) + shift ) ; or$$

$${L}_{b} = max ( 1 , max ( 3 , 3 \times round ( L 1 - L 2 / 3 ) ) + shift ) .$$

A calculation mode for the shift in the specific implementation solutions may be any one of the following modes:

(1) The encoder obtains shift by looking up a preset lookup table T. For example, an index value of the lookup table is calculated based on a geometry quantization parameter, an attribute quantization parameter, and a quantization offset parameter, and then a value of the shift is determined in the lookup table T based on the determined index value.

(2) The encoder determines the offset value based on an attribute feature obtained by parsing a bitstream of the target point cloud, such as a header information parameter attrQuantParam and a possible QPOffset.

(3) The encoder may further directly acquire a fixed value of the shift, and determine the fixed value as the value of the shift. The directly acquired fixed value may be defaulted by the encoder/decoder side, or may be a parameter required by the encoder in a process of encoding the target point cloud.

(4) The encoder may further determine a fixed value corresponding to the preset identifier as the offset value shift, where different preset identifiers correspond to different fixed values. For example, when the preset identifier is C1, the offset value is c1, when the preset identifier is C2, the offset value is c2, and both c1 and c2 are positive numbers. The foregoing preset identifier may be defaulted by the encoder/decoder side, or may be required by the decoder to encode the target point cloud, or may be determined based on the lookup table.

Implementation example 10:

In this embodiment, a value of the initial grouping step size in the grouping information is an integer multiple of the target fixed value, for example, ‘L₁’ in the foregoing “implementation example 8” is 32, where L₁ is an integer multiple of 1, and in this embodiment, the “target fixed value” is 1. In one or more embodiments of this disclosure, the target fixed value may be determined by the encoder based on the target feature of the target point cloud; or the target fixed value may be determined by the encoder based on the preset identifier, and different preset identifiers correspond to different fixed values, so that the target fixed value may be determined based on the preset identifier; or the target fixed value may be a first default value determined by the encoder in the target parameter information.

In some embodiments, an implementation of S610 may include the following operation S1 to operation S2:

S1: Determine a target fixed value based on a target feature of a target point cloud; or determine the target fixed value based on a preset identifier, where different preset identifiers correspond to different fixed values; or determine a first default value in the target parameter information as the target fixed value.

S2: Determine an integer multiple of the target fixed value as a value of the initial grouping step size.

In some embodiments, the target feature used in S1 may be a fixed parameter defaulted by the encoder/decoder side, or may be one or more of the coding parameter information, point cloud feature information, and bounding box information.

For example, when the target feature employs a point cloud type in the point cloud characteristic information, a value of the target fixed value is determined as m when the point cloud type is a dense type or a human eye vision type; or when the type of the point cloud is a sparse type or a dense vision type, the target fixed value is determined as n, where values of m and n are positive integers.

For example, the value of m is 3, and the value of n is 1. For example, if the target feature is of the point cloud type and the point cloud type is the dense type, a value of the initial grouping step size may be an integer multiple of 3. Values of m and n are not limited in this disclosure.

For example, when the target feature employs the bounding box information, the target fixed value is determined as p when correlation among three sides of the bounding box satisfies a preset condition; or the target fixed value is determined as q when the correlation among the three sides of the bounding box does not satisfy a preset condition, where values of p and q are positive integers. The preset condition may be whether the correlation is greater than a preset value (such as 80%). In at least one aspect, the correlation among the lengths of the three sides may be determined by using a variance or a standard deviation of the lengths of the three sides. For example, if boundingbox_size_z is far less than or far greater than boundingbox_size_x or boundingbox_size_y, a length similarity of the three sides of the bounding box is relatively small.

For example, a value of p is 3, and a value of q is 1. For example, if the variance among boundingbox_size_z, boundingbox_size_x, and boundingbox_size_y is less than a preset value, the length similarity of the three sides of the bounding box is high, and the value of the initial grouping step size may be an integer multiple of 3. Values of p and q are not limited in this disclosure.

For example, the target fixed value may further be determined based on the coding parameter information, for example, determined based on a geometry quantization parameter and/or an attribute quantization parameter.

In some other embodiments, the preset identifier in S1 may be defaulted by the encoder/decoder side, or may be information required by the encoder to encode the target point cloud, or may be determined based on a preset lookup table. For example, when the encoder determines that the identifier is Q1 in an encoding process, a fixed value corresponding to the identifier Q1 is determined as the target fixed value. In addition, the encoder may further directly encode the first default value into a bitstream, and determine the first default value as the target fixed value. The first default value may be defaulted by the encoder/decoder side, or may be required for encoding the target point cloud.

An implementation for determining the initial grouping step size is not limited to the foregoing embodiments. For example, the initial grouping step size may alternatively be another combination of the target features and another combination of the target feature and constants. This is not limited in this disclosure.

The following describes an implementation of S610-B, i.e., an implementation of calculating an intermediate value of the initial grouping step size L_{b}:

In some applications, when an attribute is reflectivity, in an attribute prediction process, an expression formula of the initial grouping step size is as follows:

$${L}_{b a s e} = max ( 3 , 3 * ( \frac{max Bits - min Bits}{3} ) ) + shift$$

The intermediate value for determining the initial grouping step size L_{base} is the offset value shift, or may be a maximum number of bits maxBits and a minimum number of bits minBits.

This embodiment of this disclosure may be the same as the embodiment corresponding to S610-A. The encoder may directly determine the initial grouping step size L_{b} based on the target feature, or may determine the intermediate value of the initial grouping step size L_{base} in some applications based on the target feature. The encoder may further determine a second default value in the target parameter information as the intermediate value. The second default value may be defaulted by the encoder/decoder side, or may be required by the encoder to encode the target point cloud, or may be determined based on the preset lookup table. The encoder may further determine a fixed value corresponding to the preset identifier in the target parameter information as the intermediate value, where different preset identifiers correspond to different fixed values.

For example, the maximum number of bits maxbits is Logs(V(bounding_box)); and the minimum number of bits minbits is ceilLogs(B), where maxbits denotes the maximum number of bits, V (bounding_box) denotes a volume of the bounding box, minbits denotes the minimum number of bits, and B denotes a fixed parameter.

For example, the maximum number of bits maxbits is Logs(num_points); a value of the minimum number of bits minbits varies based on the type of the target point cloud. Num_points denotes the number of points in the target point cloud.

For example, the offset value shift may be determined based on the attribute feature obtained by parsing the bitstream of the target point cloud, such as the header information parameter attrQuantParam and the possible QPOffset.

For example, the offset value may further be determined based on a fixed parameter X1 determined by looking up a preset table, where the preset table is generated before or when the encoder encodes the target point cloud.

For example, the offset value shift may be determined based on a fixed parameter X2 obtained by parsing the bitstream of the target point cloud. For example, shift=ceil(log₂(X2)).

It can be learned that, in one or more embodiments of this disclosure, various combinations of the target features and the mapping values thereof may be determined through operation S420-2A or operation S420-2B, thereby providing multiple modes for determining the intermediate value. A specific combination mode is not limited in this disclosure.

An implementation of S410-C, namely, an implementation of determining an upper limit value or a lower limit value of the initial grouping step size L_{b} includes, but is not limited to the following modes:

(1) The encoder determines an obtained third default value as an upper limit value of the intermediate value (such as shift, maxbits, or minbits), and determines an obtained fourth default value as a lower limit value of the intermediate value (such as shift, maxbits, or minbits). For example, the encoder uses a fixed value a as an upper limit value of the intermediate value shift, and uses a fixed value b as an upper limit value of shift. Values of a and b are positive numbers, and a is greater than b. For example, the fixed value a and the fixed value b may be defaulted by the encoder/decoder side, or may be required by the encoder to encode the target point cloud. In another embodiment, the encoder may determine the fixed value a based on a first preset identifier, and determine the fixed value b based on a second preset identifier, where the first preset identifier indicates that the upper limit value of shift is set to the corresponding fixed value a, and the second preset identifier indicates that the lower limit value of shift is set to the corresponding fixed value b. The first preset identifier and the second preset identifier may be defaulted by the encoder/decoder side, or may be required by the encoder to encode the target point cloud.

In at least one aspect, the encoder uses a fixed value c as an upper limit value of the initial grouping step size L_{b}, and uses a fixed value d as a lower limit value of the initial grouping step size L_{b}. Values of c and d are positive numbers, and c is greater than d. For example, the fixed value c and the fixed value d may be defaulted by the encoder/decoder side, or may be a feature required by the encoder to encode the target point cloud. In another embodiment, the encoder may determine the fixed value c based on a first preset identifier, and determine the fixed value d based on a second preset identifier. The first preset identifier indicates that the upper limit value of L_{b} is set as the corresponding fixed value c, and the second preset identifier indicates that the lower limit value of L_{b} is set as the corresponding fixed value d. The first preset identifier and the second preset identifier may be defaulted by the encoder/decoder side, or may be a feature required by the encoder to encode the target point cloud.

(2) The encoder may determine the upper limit value and the lower limit value of the initial grouping step size L_{b} or the intermediate value based on the point cloud type; for example, compared with the point cloud of the sparse type, the upper limit value and the lower limit value of the initial grouping step size L_{b} of the point cloud of the dense type are both relatively small. For example, for the dense-type point cloud, the upper limit value of the initial grouping step size L_{b} is z1 and the lower limit value is z2; for a sparse-type point cloud, the upper limit value of the initial grouping step size L_{b} is z3 and the lower limit value is z4; and a value of z1 is less than z3, and the value of z2 is less than z4.

(3) The encoder may determine the upper limit value and the lower limit value of the initial grouping step size L_{b} or the intermediate value based on the coding parameter information; for example, the upper limit value and the lower limit value of L_{b} are determined based on a geometric output bit depth, an attribute output bit depth, a geometric quantization parameter, and an attribute quantization parameter; for example, the upper limit value and the lower limit value of L_{b} may further be determined according to a transform method, a prediction method, and a sorting method; if the transform method is predictive transform encoding, the upper limit value of the initial grouping step size L_{b} is determined as s1, the lower limit value is s2, and s1 is greater than s2; if the transform method is improved transform encoding, the upper limit value of the initial grouping step size L_{b} is determined as s3, the lower limit value is determined as s4, and s3 is greater than s4; and s1 and s3 may be different positive numbers, and s2 and s4 may further be different positive numbers.

(4) The encoder may determine the upper limit value and the lower limit value of the initial grouping step size L_{b} or the intermediate value based on the bounding box parameter information such as side lengths of a bounding box, and correlation of the side lengths.

An implementation for determining the upper limit value and the lower limit value of the initial grouping step size L_{b} or the intermediate value is not limited to the aforementioned content and may be other forms based on the aforementioned target feature.

Refer to FIG. 7. S620: Group second reconstructed position points based on the grouping information to obtain a plurality of groups, where the second reconstructed position points are encoded into a geometry bitstream of the target point cloud through an encoder. In some examples, predicted attributes of the target point cloud and corresponding reconstructed position points of the target point cloud are determined by processing circuitry. In some examples, the reconstructed position points are grouped, by the processing circuitry, into a plurality of groups of position points based on the grouping information.

S630: Perform attribute encoding on each group. In some examples, the reconstructed position points are encoded into a geometry bitstream of the target point cloud. In some examples, the respective attributes of each group of the plurality of groups of position points are encoded into an attribute bitstream of the target point cloud.

In an embodiment, the encoder determines an initial grouping step size in the grouping information according to the foregoing embodiment. The encoder groups the reordered reconstructed position points based on the initial grouping step size. An implementation of grouping is described in detail in an embodiment corresponding to FIG. 8. Further, the encoder performs attribute encoding based on the grouped reconstructed position points, thereby completing a process of encoding the bitstream of the target point cloud, to obtain a reconstructed point cloud of the target point cloud.

In the point cloud encoding solution P600 provided in at least one embodiment of this disclosure, the encoder determines the grouping information based on one or more of the following information defaulted by an encoder/decoder side or related to encoding a bitstream of the target point cloud: point cloud characteristic information, bounding box information, coding parameter information, and target parameter information. In an attribute encoding process, the encoder groups first reconstructed position points based on the grouping information, to obtain a plurality of groups. The second reconstructed position points are obtained by decoding a geometry bitstream of the target point cloud through the encoder. Further, the encoder performs attribute encoding on each group. In the encoding solution provided in at least one embodiment of this disclosure, the encoder determines the grouping information based on the target feature. The grouping information is, for example, the initial grouping step size, an intermediate value for determining the initial grouping step size, and an upper limit value and a lower limit value of the initial grouping step size. In at least one embodiment of this disclosure, the grouping information is determined based on the diversified feature related to the target point cloud. Compared to the method for determining the initial grouping step size provided in other applications, an implementation based on one or more embodiments of this disclosure can enhance grouping diversity, thereby improving the encoding performance of the point cloud.

FIG. 8 is a schematic flowchart of a point cloud encoding method P700 according to another embodiment of this disclosure. The point cloud encoding method P700 may be performed by an encoder, or may be performed by an electronic device executing an encoding process. Referring to FIG. 8, the point cloud encoding method P700 includes S72 to S78.

S72: The encoder performs geometry encoding on a geometry bitstream of a target point cloud, to obtain second reconstructed position points.

In at least one embodiment of this disclosure, the reconstructed position points obtained by the encoder side in an attribute prediction stage are written as first reconstructed position points. In addition, the reconstructed position points obtained by encoding the geometry bitstream through a decoder in an attribute reconstruction stage are written as first reconstructed position points.

In at least one embodiment of this disclosure, a reconstruction order of a point cloud geometry coordinate includes, but is not limited to the following modes:

(a) After slice geometry information is decoded and reconstructed as xyz, the encoder performs an overall reconstruction on the geometry information of a current slice, namely, the final reconstructed geometry information is: rec_xyz=xyz+gsh_bounding_box_offset. Gsh_bounding_box_offset denotes a coordinate of an origin xyz of a slice bounding box.

(b) After the slice attribute information is decoded and reconstructed, the encoder performs overall reconstruction on geometry information of the current slice.

S74: The encoder reorders the second reconstructed position points.

A mode for reordering the second reconstructed position points is not limited in this disclosure. For example, the encoder may perform reordering based on an input order of the point cloud; or the encoder may perform reordering based on an order of a point cloud space curve (including a Morton order and a Hilbert order); or the encoder may perform reordering based on information (such as collection information and Lidar information) about input parameters, and the like.

S76: The encoder determines grouping information and groups the second reconstructed position points based on the grouping information.

An implementation for determining the grouping information by using the encoder is described in detail in the embodiment corresponding to P600, and details are not described herein again.

In at least one embodiment of this disclosure, for example, the second reconstructed position points are re-ordered according to the Hilbert order, and the re-ordered points correspond to Hilbert codes. In a case where the grouping information determined in the foregoing embodiment is the initial grouping step size L_{b}, the Hilbert codes corresponding to the first reconstructed position points may be grouped in the following mode:
(1) Based on the determined initial grouping step size L_{b}, the encoder performs initial grouping on the second reconstructed position points; and
points with identical values after right-shifting the Hilbert codes by the initial grouping step size L_{b} are assigned to a same macroblock.
(2) The encoder determines whether the Hilbert codes in the same macroblock need to be sub-grouped;
for the points in each macroblock, the encoder may determine whether there is a repeated point in the current macroblock. If there is the repeated point in the current macroblock, grouping is truncated at the repeated point, and the repeated points are independently grouped, namely, the repeated points are grouped based on a point number of 1. Assuming that the current macroblock includes four points, and the fourth point is a repeated point, the first three points may be grouped together, and the fourth repeated point is placed in a separate group.

In some applications, in a color reconstruction process, if the number of points in a current block is less than or equal to a maximum transform order colorMaxTransNum, the points in the macroblock are grouped together; and if the number of points in the current block is greater than colorMaxTransNum, the points in the block are sub-grouped. A sub-grouping rule is: a current right-shifting number L is acquired, a value of a right-shifting number L₁ of the current sub-grouping is L−1, and the identical points after right-shifting the Hilbert code by L₁ bits are assigned into a new sub-group; and whether the number of points in the sub-group is greater than colorMaxTransNum is further determined until the number of points in each sub-group is less than or equal to colorMaxTransNum.

In some applications, in a reflectivity reconstruction process, if the number of points in the current macroblock is greater than a maximum transform order reflMaxTransNum, the encoder sequentially selects points of the maximum transform order reflMaxTransNum as one sub-group until the number of points in each group in the macroblock is less than or equal to reflMaxTransNum.

In at least one embodiment of this disclosure, a method provided in some applications may be employed to determine whether the points in the macroblock need to be sub-grouped.
(3) The encoder determines whether the grouping step size needs to be updated.

In some applications, in a color reconstruction process, statistics is performed on a sum of numbers of points in first three consecutive groups, and the sum is right-shifted by three bits (divided by 8), to be written as B. If a value of B is less than 2, an updated step size L is equal to L+1; if the value of B is greater than 8, the updated step size L is equal to L−1; and If B is greater than or equal to 2 and less than or equal to 8, the step size L is not updated.

In some applications, in the reflectivity reconstruction process, if the maximum transform order reflMaxTransNum is greater than 2 and an offset value shift in the initial grouping step size is greater than 0, the encoder updates the grouping step size; and otherwise, the current grouping step size remains unchanged. In at least one embodiment, the encoder performs statistics on a total number of points in first N groups, and calculates an average number of points in the N (for example, N is equal to 8) groups, and if the average number of points is less than 2, the updated grouping step size L is equal to L+1; if the average number of points is greater than the maximum transform order reflMaxTransNum, an updated grouping step size is equal to L−1; and if the average number of points is greater than or equal to 2 and less than or equal to the maximum transform order reflMaxTransNum, the grouping step size L further remains unchanged.

It can be learned that in some applications the numbers of points in first multiple groups are considered when determining whether to update the grouping step size. In some applications, the sub-group of one point formed by the repeated points may further be taken as the first group and employed to determine whether to update the grouping step size, namely, the number of points in the group formed by the repeated points is considered in some applications.

In at least one embodiment of this disclosure, a method for sub-grouping the points in the current macroblock includes but is not limited to the following:

(a) The encoder performs statistics on numbers of points corresponding to first N groups that are directly grouped based on the grouping step size information, where the direct grouping is sub-grouping, i.e., grouping determined based on the grouping step size. In at least one aspect, whether to update the grouping step size is determined based on the number of points.

b) The encoder performs statistics on the numbers of points corresponding to the first N groups that do not include repeated points. This method differs from the method in some other applications in which when determining whether to update the grouping step size requires the statistics of the number of repeated points. In at least one embodiment of this disclosure, whether the grouping step size needs to be updated is determined by performing statistics on the number of points in a group that does not include the repeated points.

In at least one embodiment of this disclosure, a grouping step size updating method is more flexible, which is conducive to improving encoding performance.

Refer to FIG. 8. S78: The encoder performs intra-group attribute encoding.

In an embodiment, after all the second reconstructed position points are grouped, an attribute encoding process may be performed on each group obtained through grouping. In another embodiment, after the sub-groups of each macroblock are determined, an attribute encoding process may be performed on the completed groups of the current macroblock while a next macroblock is processed, thereby improving overall encoding efficiency.

In the point cloud encoding method P700 provided in at least one embodiment of this disclosure, which is the same as in the method P600, an encoder determines the grouping information based on target parameters defaulted by an encoder/decoder side or one or more of the following information related to encoding a bitstream of the target point cloud: point cloud characteristic information, bounding box information, coding parameter information, and target parameter information, so that grouping diversity can be enhanced, and the encoding performance of the point cloud can be improved. Furthermore, compared with some other applications, the point cloud encoding method P700 provided in this embodiment not only improves a mode of determining the initial grouping step size and an intermediate value of the initial grouping step size to diversify the grouping, but also extends a mode of determining whether to update the grouping step size to provide an optimized processing solution for the attribute encoding process, and extends a geometry reconstruction mode. The foregoing improvements are conducive to improving the encoding performance of the point cloud.

The point cloud decoding method and point cloud encoding method embodiments in this disclosure are described in detail above. Referring to FIG. 9 to FIG. 12, the following describes a decoder and encoder embodiments provided in this disclosure, respectively.

FIG. 9 is a schematic structural diagram of a decoder according to an embodiment of this disclosure. The decoder 900 may be an electronic device for decoding a bitstream of a target point cloud. Referring to FIG. 9, the decoder 900 includes: a first determining module 910, a decoding grouping module 920, and an attribute decoding module 930.

The first determining module 910 is configured to determine grouping information based on a target feature of a target point cloud, where the target feature includes one or more of the following information: point cloud characteristic information, bounding box information, coding parameter information, and target parameter information; the decoding grouping module 920 is configured to group first reconstructed position points based on the grouping information, to obtain a plurality of groups, where the first reconstructed position points are obtained by decoding a geometry bitstream of the target point cloud through the decoder; and the attribute decoding module 930 is configured to perform attribute decoding on each group.

In some embodiments, based on the foregoing solution, the point cloud characteristic information includes one or more of the following information: a point cloud type, a point cloud density, a point cloud space occupation ratio, a resolution, and a number of point cloud points.

In some embodiments, based on the foregoing solution, the bounding box information includes one or more of the following information: lengths and directions of three sides of a bounding box of the target point cloud, and statistical values of lengths of the three sides. The statistical values of the lengths of the three sides include one or more of the following information: an average length value of the three sides, a medium length value of the three sides, a mode length value of the three sides, a maximum length value of the three sides, a minimum length value of the three sides, a linear combination of lengths of at least two sides, a linear combination of a length of at least one side and a constant, a volume of the bounding box, and a surface area of the bounding box.

In some embodiments, based on the foregoing solution, the coding parameter information includes one or more of the following information: an attribute predictive transform maximum transform order, a geometry output bit depth, an attribute output bit depth, a geometry quantization parameter, an attribute quantization parameter, a transform method, a prediction method, and an ordering method.

In some embodiments, based on the foregoing solution, the target parameter information may further be determined by looking up a preset table through the decoder, and the preset table is determined when the encoder encodes the target point cloud.

In some embodiments, based on the foregoing solution, the first determining module 910 is configured to: map at least one of target features by using a target function, to obtain at least one mapping value; determine grouping information based on a combination of the at least one mapping value and a constant; or determine grouping information based on a combination of the mapping values; or determine the grouping information based on a combination of the at least one mapping value and an unmapped target feature.

In some embodiments, based on the foregoing solution, the decoder 900 further includes a rounding module; and

the rounding module is configured to: perform rounding calculation after a logarithmic operation when the target function includes the logarithmic operation; or perform the rounding calculation after a division operation when the target function includes the division operation.

In some embodiments, based on the foregoing solution, the first determining module 910 includes a step size determining unit; and

the step size determining unit is configured to determine an initial grouping step size in the grouping information based on the target feature of the target point cloud.

In some embodiments, based on the foregoing solution, for the initial grouping step size in the grouping information, the step size determining unit includes: a fixed value determining subunit and a step size determining subunit.

The fixed value determining subunit is configured to determine a target fixed value based on at least one of the point cloud characteristic information, the bounding box information, or the coding parameter information in the target feature; or determine the target fixed value based on a preset identifier in the target parameter information, where different preset identifiers correspond to different fixed values; or determine a first default value in the target parameter information as the target fixed value; and the step size determining subunit is configured to determine an integer multiple of the target fixed value as a value of the initial grouping step size.

In some embodiments, based on the foregoing solution, the fixed value determining subunit is configured to: determine that the target fixed value takes a value of m when the target feature is of a point cloud type and when the point cloud type is a dense type or a human eye vision type; or determine that the target fixed value takes a value of n when the point cloud type is a sparse type or a machine vision type, where the values of m and n are positive integers.

In some embodiments, based on the foregoing solution, the fixed value determining subunit is configured to: determine that the target fixed value takes a value of p when the target feature is the bounding box information, and when the target feature indicates that the correlation of three sides of the bounding box satisfies a preset condition; or determine that the target fixed value takes a value of q when the target feature indicates that the correlation of the three sides of the bounding box does not satisfy the preset condition, where the values of p and q are positive integers.

In some embodiments, for the initial grouping step size in the grouping information, based on the foregoing solution, the first determining module 910 includes an intermediate value determining unit; and

the intermediate value determining unit is configured to determine an intermediate value of the initial grouping step size based on at least one of the point cloud characteristic information, the bounding box information, or the coding parameter information in the target feature; or determine a fixed value corresponding to the preset identifier in the target parameter information as the intermediate value, where different preset identifiers correspond to different fixed values; or determine a second default value in the target parameter information as the intermediate value; and determine the initial grouping step size based on the intermediate value to obtain the grouping information.

In some embodiments, for the initial grouping step size in the grouping information, based on the foregoing solution, the first determining module 910 includes: a limit value determining unit; and
the limit value determining unit is configured to:
determine at least one of an upper limit value or a lower limit value of the initial grouping step size in the grouping information based on at least one of the point cloud characteristic information, the bounding box information, or the coding parameter information in the target feature; or determine a third default value in the target parameter information as an upper limit value of the intermediate value, and determine a fourth default value in the target parameter information as a lower limit value of the intermediate value, the intermediate value being configured for determining the initial grouping step size; or determine a fixed value corresponding to the first preset identifier in the target parameter information as an upper limit value of the initial grouping step size or the intermediate value, and determine a fixed value corresponding to the second preset identifier in the target parameter information as a lower limit value of the initial grouping step size or the intermediate value, where different preset identifiers correspond to different fixed values.

The decoder embodiments and the point cloud decoding method embodiments may correspond to each other. For similar descriptions, refer to the point cloud decoding method embodiments. To avoid repetition, details are not described here. In at least one aspect, the decoder shown in FIG. 9 may perform the foregoing point cloud decoding method embodiments, and the foregoing and another operation and/or function of the modules in the apparatus are separately intended to implement the method embodiments corresponding to nodes in a main node group. For brevity, details are not described herein again.

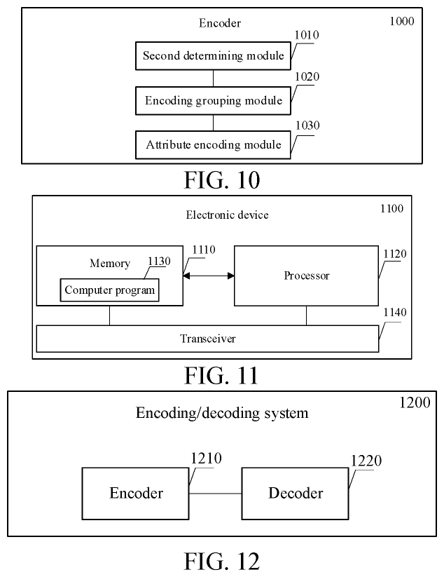

FIG. 10 is a schematic structural diagram of an encoder according to an embodiment of this disclosure. An encoder 1000 may be an electronic device that encodes a bitstream of a target point cloud. Referring to FIG. 10, the encoder 1000 includes: a second determining module 1010, an encoding grouping module 1020, and an attribute encoding module 1030.

The second determining module 1010 is configured to determine grouping information based on a target feature of a target point cloud, where the target feature includes one or more of the following information: point cloud characteristic information, bounding box information, coding parameter information, and target parameter information; the encoding grouping module 1020 is configured to group second reconstructed position points based on the grouping information, to obtain a plurality of groups, where the second reconstructed position points are obtained by performing geometry encoding on a geometry bitstream of the target point cloud through the encoder; and the attribute encoding module 1030 is configured to perform attribute encoding on each group.

In some embodiments, based on the foregoing solution, the point cloud characteristic information includes one or more of the following information: a point cloud type, a point cloud density, a point cloud space occupation ratio, a resolution, and a number of point cloud points.

In some embodiments, based on the foregoing solution, the bounding box information includes one or more of the following information: lengths and directions of three sides of a bounding box of the target point cloud, and statistical values of lengths of the three sides. The statistical values of the lengths of the three sides include one or more of the following information: an average length value of the three sides, a medium length value of the three sides, a mode length value of the three sides, a maximum length value of the three sides, a minimum length value of the three sides, a linear combination of lengths of at least two sides, a linear combination of a length of at least one side and a constant, a volume of the bounding box, and a surface area of the bounding box.

In some embodiments, based on the foregoing solution, the coding parameter information includes one or more of the following information: an attribute predictive transform maximum transform order, a geometry output bit depth, an attribute output bit depth, a geometry quantization parameter, an attribute quantization parameter, a transform method, a prediction method, and an ordering method.

In some embodiments, based on the foregoing solution, the target parameter information may further be determined by looking up a preset table through the encoder, and the preset table is determined when the encoder encodes the target point cloud.

In some embodiments, based on the foregoing solution, the second determining module 1010 is configured to: map at least one of the target features by using a target function, to obtain at least one mapping value; determine grouping information based on a combination of the at least one mapping value and a constant; or determine grouping information based on a combination of the mapping values; or determine the grouping information based on a combination of the at least one mapping value and an unmapped target feature.

In some embodiments, based on the foregoing solution, the encoder 1000 further includes: a rounding module; and

the rounding module is configured to: perform rounding calculation after a logarithmic operation when the target function includes the logarithmic operation; or perform the rounding calculation after a division operation when the target function includes the division operation.

In some embodiments, for the initial grouping step size in the grouping information, based on the foregoing solution, the second determining module 1010 includes: a step size determining unit; and

the step size determining unit is configured to determine the initial grouping step size in the grouping information based on the target feature of the target point cloud.

In some embodiments, for the initial grouping step size in the grouping information, based on the foregoing solution, the step size determining unit includes a fixed value determining subunit and a step size determining subunit; and

the fixed value determining subunit is configured to determine a target fixed value based on at least one of the point cloud characteristic information, the bounding box information, or the coding parameter information in the target feature; or determine the target fixed value according to a preset identifier in the target parameter information, where different preset identifiers correspond to different fixed values; or determine a default value in the target parameter information as the target fixed value; and the step size determining subunit is configured to determine an integer multiple of the target fixed value as a value of the initial grouping step size.

In some embodiments, based on the foregoing solution, the fixed value determining subunit is configured to: determine that the target fixed value takes a value of m when the target feature is of a point cloud type and when the point cloud type is a dense type or a human eye vision type; or determine that the target fixed value takes a value of n when the point cloud type is a sparse type or a machine vision type, where the values of m and n are positive integers.

In some embodiments, based on the foregoing solution, the fixed value determining subunit is configured to: determine that the target fixed value takes a value of p when the target feature is the bounding box information, and when the correlation of three sides of a bounding box satisfies a preset condition; or determine that the target fixed value takes a value of q when the correlation of the three sides of the bounding box does not satisfy the preset condition, where the values of p and q are positive integers.

In some embodiments, for the initial grouping step size in the grouping information, based on the foregoing solution, the second determining module 1010 includes an intermediate value determining unit; and

the intermediate value determining unit is configured to determine an intermediate value of the initial grouping step size based on at least one of the point cloud characteristic information, the bounding box information, or the coding parameter information in the target feature; or determine a fixed value corresponding to the preset identifier in the target parameter information as the intermediate value, where different preset identifiers correspond to different fixed values; or determine a second default value in the target parameter information as the intermediate value; and determine the initial grouping step size based on the intermediate value to obtain the grouping information.

In some embodiments, for the initial grouping step size in the grouping information, based on the foregoing solution, the second determining module 1010 includes: a limit value determining unit; and

the limit value determining unit is configured to: determine at least one of an upper limit value or a lower limit value of the initial grouping step size in the grouping information based on at least one of the point cloud characteristic information, the bounding box information, or the coding parameter information in the target feature; or determine a third default value in the target parameter information as an upper limit value of the intermediate value, and determine a fourth default value in the target parameter information as a lower limit value of the intermediate value, the intermediate value being configured for determining the initial grouping step size; or determine a fixed value corresponding to the first preset identifier in the target parameter information as the upper limit value of the initial grouping step size or the intermediate value, and determine a fixed value corresponding to the second preset identifier in the target parameter information as the lower limit value of the initial grouping step size or the intermediate value, where different preset identifiers correspond to different fixed values.

The encoder embodiments and the point cloud encoding method embodiments may correspond to each other. For similar descriptions, refer to the point cloud encoding method embodiments. To avoid repetition, details are not described here. In at least one aspect, the encoder shown in FIG. 10 may perform the foregoing point cloud encoding method embodiments, and the foregoing and another operation and/or function of the modules in the encoder apparatus are separately intended to implement the method embodiments corresponding to nodes in a main node group. For brevity, details are not described herein again.

FIG. 11 is a schematic structural diagram of an electronic device according to another embodiment of this disclosure. An electronic device 1100 in FIG. 11 may be configured to perform the point cloud encoding method or the point cloud decoding method.

As shown in FIG. 11, the electronic device 1100 may include: a memory 1110 (e.g., including a non-transitory computer-readable storage medium) and processing circuitry (e.g., a processor 1120). The memory 1110 is configured to store a computer program 1130 and transmit the computer program 1130 to the processor 1120. In other words, the processor 1120 may invoke the computer program 1130 from the memory 1110 and run the computer program to implement the point cloud decoding method or the point cloud encoding method in one or more embodiments of this disclosure.

For example, the processor 1120 may be configured to perform the operations in the foregoing method based on instructions in the computer program 1130.

In some embodiments of this disclosure, the processor 1120 may include, but is not limited to:

a general-purpose processor, a digital signal processor (DSP), an application specific integrated circuit (ASIC), a field programmable gate array (FPGA), or another programmable logic device, a discrete gate or transistor logic device, or a discrete hardware component.

In some embodiments of this disclosure, the memory 1110 includes but is not limited to:

a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be random access memory (RAM), serving as an external cache. By way of illustration but not limitation, the RAM in a lot of forms is available, such as static RAM (SRAM), dynamic RAM (DRAM), synchronous DRAM (SDRAM), double data rate SDRAM (DDR SDRAM), enhanced SDRAM (ESDRAM), synch DRAM (SLDRAM) and direct Rambus RAM (DR RAM). In at least one aspect, the memory 1110 includes a non-transitory computer-readable storage medium configured to store executable instructions, such as the computer program 1130.

In some embodiments of this disclosure, the computer program 1130 may be segmented into one or more modules. The one or more modules are stored in the memory 1110 and executed by the processor 1120, to implement a page recording method provided in this disclosure. The one or more modules may be a series of computer program instruction segments that can implement specific functions. The instruction segments are configured for describing an execution process of the computer program 1130 in the electronic device.

As shown in FIG. 11, the electronic device 1100 may further include: a transceiver 1140. The transceiver 1140 may be connected to the processor 1120 or the memory 1110.

The processor 1120 may control the transceiver 1140 to be communicated with another device; and the transceiver may transmit information or data to another device, or receive information or data transmitted by another device. The transceiver 1140 may include a transmitter and a receiver. The transceiver 1140 may further include an antenna, and the number of the antenna may be one or more.

Components in the electronic device 1100 are connected through a bus system. In addition to a data bus, the bus system further includes a power bus, a control bus, and a status signal bus.

FIG. 12 is a schematic structural diagram of an encoding/decoding system according to an embodiment of this disclosure. As shown in FIG. 12, the encoding/decoding system 1200 may include an encoder 1210 and a decoder 1220.

In at least one embodiment of this disclosure, the encoder 1210 may be the encoder according to any one of the foregoing embodiments, and the decoder 1220 may be the decoder according to any one of the foregoing embodiments.

The apparatus in at least one embodiment of this disclosure is described above with reference to the accompanying drawings from the perspective of functional modules. The functional module may be implemented in a form of hardware, or may be implemented in a form of software, or may be implemented in a combination of hardware and software modules. The operations of one or more method examples in this disclosure may be performed by an integrated logic circuit of hardware in the processor and/or instructions in a form of software. The operations of one or more method examples disclosed in this disclosure may be directly embodied as being completed by a hardware decoding processor, or may be completed by a combination of hardware and software modules in the decoding processor. In some embodiments, the software module may be located in a storage medium that is mature in the art, such as a random access memory, a flash memory, a read-only memory, a programmable read-only memory, an electrically erasable programmable memory, or a register. The storage medium is located in the memory, and a processor reads information in the memory and completes the operations in the foregoing method embodiments in combination with hardware thereof.

According to one aspect of this disclosure, provided is a non-transitory computer storage medium having a computer program stored therein, the computer program, when executed by processing circuitry of a computer, causing the processing circuitry of the computer to perform the method in the foregoing method embodiments. In some aspects, an embodiment of this disclosure further provides a computer program product including instructions, and the instructions, when executed by processing circuitry of a computer, causing the processing circuitry of the computer to perform the method in the foregoing method embodiments.

According to another aspect of this disclosure, a computer program product or a computer program is provided, the computer program product or the computer program including computer instructions, and the computer instructions being stored in a non-transitory computer-readable storage medium. Processing circuitry (e.g., a processor) of a computer device reads the computer instructions from the non-transitory computer-readable storage medium, and the processor executes the computer instructions, causing the computer device to perform the method in the foregoing embodiments.

In other words, when implemented by using software, all or some of the operations may be implemented in a form of the computer program product. The computer program product includes one or more computer instructions. When the computer instruction is loaded and executed on the computer, all or some processes or functions according to one or more embodiments of this disclosure are generated. The computer may be a general-purpose computer, a dedicated computer, a computer network, or another programmable apparatus. The computer instructions may be stored in a non-transitory computer-readable storage medium, or may be transmitted from one computer-readable storage medium to another computer-readable storage medium, for example, the computer instructions may be transmitted from a web site, a computer, a server or a data center to another web site, computer, server or data center through a cable (such as a coaxial cable, an optical fiber, a digital subscriber line (DSL)), or in a wireless way (such as infrared, wireless, microwaves, etc.). The non-transitory computer-readable storage medium may be any available medium that is accessible to the computer or a data storage device including one or more available media such as a server, and a data center. The available medium may be a magnetic medium (such as floppy disk, hard disk, magnetic tape), an optical medium (such as digital video disc (DVD)), or a semiconductor medium (such as solid state disk (SSD)), etc.

Those of ordinary skill in the art may realize that modules and algorithm steps of various examples described in one or more embodiments disclosed herein can be implemented by electronic hardware or a combination of computer software and the electronic hardware. Whether these functions are executed with hardware or software depends on the specific application and designed constraint conditions of the technical solution. A Person or ordinary skill in the art can use different methods to implement the described functions for each specific application, but such implementation is not to be considered beyond the scope of this disclosure.

In one or more embodiments provided in this disclosure, the disclosed systems, apparatuses and methods may be implemented in other ways. For example, the apparatus embodiments described above are merely illustrative. For example, the division of the modules is only a logical function division, and there may be other divisions in actual implementation, for example, multiple modules or components may be combined or integrated into another system, or some features may be ignored or not implemented. In addition, the displayed or discussed mutual coupling or direct coupling or communication connection may be indirect coupling or communication connection through interfaces, apparatuses or modules, and may be in electrical, mechanical or other forms.

The modules serving as separate components may or may not be physically separated, and the components serving as module display may or may not be physical modules, that is, the modules may be located in one place or may be distributed on a plurality of network units. Some or all of the modules may be selected according to actual needs to achieve the purposes of the solutions of the embodiments. Furthermore, all functional modules in various embodiments of this disclosure may be integrated into one processing module, may further be physically separated, or two or more of the functional modules may be integrated into one module.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting examples of this disclosure, and are not intended to limit the scope of this disclosure. Other variations or replacement by a person skilled in the art within the technical scope disclosed in this disclosure shall fall within the scope of this disclosure.

What is claimed is:

1. A point cloud decoding method, the method comprising:
determining grouping information based on a target feature of a target point cloud, the grouping information including an initial grouping step size associated with the target feature, and the target feature including one or more types of information that include: point cloud characteristic information, bounding box information, coding parameter information, or target parameter information;
decoding, by processing circuitry, reconstructed position points from a geometry bitstream of the target point cloud;
grouping, by the processing circuitry, the reconstructed position points into a plurality of groups of position points based on the grouping information;
decoding attributes of each group of the plurality of groups of position points from an attribute bitstream of the target point cloud; and
obtaining reconstructed points of the target point cloud based on the reconstructed position points and the decoded attributes.

2. The method according to claim 1, wherein
the point cloud characteristic information includes one or more of: a point cloud type, a point cloud density, a point cloud space occupation ratio, a resolution, or a number of point cloud points.

3. The method according to claim 1, wherein
the bounding box information includes one or more of: lengths and directions of three sides of a bounding box of the target point cloud, or statistical values of the lengths of the three sides, and
the statistical values of the lengths of the three sides includes one or more of: an average length value of the three sides, a medium length value of the three sides, a mode length value of the three sides, a maximum length value of the three sides, a minimum length value of the three sides, a linear combination of lengths of at least two sides, a linear combination of a length of at least one side and a constant, a volume of the bounding box, or a surface area of the bounding box.

4. The method according to claim 1, wherein
the coding parameter information includes one or more of: an attribute predictive transform maximum transform order, a geometry output bit depth, an attribute output bit depth, a geometry quantization parameter, an attribute quantization parameter, a transform method, a prediction method, or an ordering method.

5. The method according to claim 1, wherein the determining the grouping information comprises:
mapping at least one type of information of the target feature by using one or more target functions, to obtain one or more mapping values; and
determining the grouping information based on a combination of the one or more mapping values and a constant, a combination of the one or more mapping values, or a combination of the one or more mapping values and an unmapped type of information of the target feature.

6. The method according to claim 5, the method further comprising, for one of the one or more target function:
performing rounding after a logarithmic operation when the one of the one or more target functions includes the logarithmic operation; or
performing the rounding after a division operation when the one of the one or more target functions includes the division operation.

7. The method according to claim 1, further comprising:
determining a target fixed value based on:
at least one of the point cloud characteristic information, the bounding box information, or the coding parameter information of the target feature;
a preset identifier in the target parameter information, different preset identifiers corresponding to different fixed values; or
a first default value in the target parameter information as the target fixed value; and
determining a value of the initial grouping step size in the grouping information based on an integer multiple of the target fixed value.

8. The method according to claim 7, wherein the determining the target fixed value comprises:
when the target feature includes the point cloud characteristic information indicating a point cloud type:
determining that the target fixed value is a value of m when the point cloud type is a dense type or a human eye vision type; or
determining that the target fixed value is a value of n when the point cloud type is a sparse type or a machine vision type, wherein the values of m and n are both positive integers; or
when the target feature includes the bounding box information:
determining that the target fixed value is a value of p when a correlation of three sides of the bounding box satisfies a preset condition; or
determining that the target fixed value is a value of q when the correlation of the three sides of the bounding box does not satisfy the preset condition, wherein the values of p and q are both positive integers.

9. The method according to claim 1, further comprising:
determining an intermediate value based on:
at least one of the point cloud characteristic information, the bounding box information, or the coding parameter information in the target feature;
a fixed value corresponding to a preset identifier in the target parameter information, different preset identifiers corresponding to different fixed values; or
a second default value in the target parameter information as the intermediate value; and
determining the initial grouping step size based on the intermediate value.

10. The method according to claim 1, further comprising:
determining at least one of an upper limit value and a lower limit value of the initial grouping step size in the grouping information based on at least one of the point cloud characteristic information, the bounding box information, or the coding parameter information in the target feature;
determining a third default value in the target parameter information as an upper limit value of an intermediate value, and determining a fourth default value in the target parameter information as a lower limit value of the intermediate value, the initial grouping step size being determined based on the intermediate value; or
determining a fixed value corresponding to a first preset identifier in the target parameter information as the upper limit value of the initial grouping step size or the upper limit value of the intermediate value, and determining a fixed value corresponding to a second preset identifier in the target parameter information as the lower limit value of the initial grouping step size or the lower limit value of the intermediate value, different preset identifiers corresponding to different fixed values.

11. A point cloud encoding method, the method comprising:
determining grouping information based on a target feature of a target point cloud, the grouping information including an initial grouping step size associated with the target feature, and the target feature including one or more types of information that include: point cloud characteristic information, bounding box information, coding parameter information, or target parameter information;
determining, by processing circuitry, predicted attributes of the target point cloud and corresponding reconstructed position points of the target point cloud;
grouping, by the processing circuitry, the reconstructed position points into a plurality of groups of position points based on the grouping information;
encoding the reconstructed position points into a geometry bitstream of the target point cloud; and
encoding the respective attributes of each group of the plurality of groups of position points into an attribute bitstream of the target point cloud.

12. The method according to claim 11, wherein
the point cloud characteristic information includes one or more of: a point cloud type, a point cloud density, a point cloud space occupation ratio, a resolution, or a number of point cloud points,
the bounding box information includes one or more of: lengths and directions of three sides of a bounding box of the target point cloud, or statistical values of lengths of the three sides,
the statistical values of the lengths of the three sides includes one or more of: an average length value of the three sides, a medium length value of the three sides, a mode length value of the three sides, a maximum length value of the three sides, a minimum length value of the three sides, a linear combination of lengths of at least two sides, a linear combination of a length of at least one side and a constant, a volume of the bounding box, or a surface area of the bounding box, and
the coding parameter information includes one or more of: an attribute predictive transform maximum transform order, a geometry output bit depth, an attribute output bit depth, a geometry quantization parameter, an attribute quantization parameter, a transform method, a prediction method, or an ordering method.

13. The method according to claim 11, wherein the determining the grouping information comprises:
mapping at least one type of information of the target feature by using one or more target functions, to obtain one or more mapping values; and
determining the grouping information based on a combination of the one or more mapping values and a constant, a combination of the one or more mapping values, or a combination of the one or more mapping values and an unmapped type of information of the target feature.

14. The method according to claim 11, further comprising:
determining a target fixed value based on:
at least one of the point cloud characteristic information, the bounding box information, or the coding parameter information in the target feature;
a preset identifier in the target parameter information, different preset identifiers corresponding to different fixed values; or
a default value in the target parameter information as the target fixed value; and
determining a value of the initial grouping step size in the grouping information based on an integer multiple of the target fixed value.

15. The method according to claim 14, wherein the determining the target fixed value comprises:
when the target feature includes the point cloud characteristic information indicating a point cloud type:
determining that the target fixed value is a value of m when the point cloud type is a dense type or a human eye vision type; or
determining that the target fixed value is a value of n when the point cloud type is a sparse type or a machine vision type, wherein the values of m and n are both positive integers; or
when the target feature includes the bounding box information:
determining that the target fixed value is a value of p when a correlation of three sides of the bounding box satisfies a preset condition; or
determining that the target fixed value is a value of q when the correlation of the three sides of the bounding box does not satisfy the preset condition, wherein the values of p and q are both positive integers.

16. The method according to claim 11, further comprising:
determining an intermediate value based on:
at least one of the point cloud characteristic information, the bounding box information, or the coding parameter information in the target feature;
a fixed value corresponding to a preset identifier in the target parameter information, different preset identifiers corresponding to different fixed values; or
a second default value in the target parameter information as the intermediate value; and
determining the initial grouping step size based on the intermediate value.

17. The method according to claim 11, further comprising:
determining at least one of an upper limit value and a lower limit value of the initial grouping step size in the grouping information based on at least one of the point cloud characteristic information, the bounding box information, or the parameter information in the target feature;
determining a third default value in the target parameter information as an upper limit value of an intermediate value, and determining a fourth default value in the target parameter information as a lower limit value of the intermediate value, the initial grouping step size being determined based on the intermediate value; or
determining a fixed value corresponding to a first preset identifier in the target parameter information as the upper limit value of the initial grouping step size or the upper limit value of the intermediate value, and determining a fixed value corresponding to a second preset identifier in the target parameter information as the lower limit value of the initial grouping step size or the lower limit value of the intermediate value, different preset identifiers corresponding to different fixed values.

18. A point cloud decoding apparatus, comprising:
processing circuitry configured to:
determine grouping information based on a target feature of a target point cloud, the grouping information including an initial grouping step size associated with the target feature, and the target feature including one or more types of information that include: point cloud characteristic information, bounding box information, coding parameter information, or target parameter information;
decode reconstructed position points from a geometry bitstream of the target point cloud;
group the reconstructed position points into a plurality of groups of position points based on the grouping information;
decode attributes of each group of the plurality of groups of position points from an attribute bitstream of the target point cloud; and
obtain reconstructed points of the target point cloud based on the reconstructed position points and the decoded attributes.

19. The point cloud decoding apparatus according to claim 18, wherein the processing circuitry is configured to:
determine a target fixed value based on:
at least one of the point cloud characteristic information, the bounding box information, or the coding parameter information of the target feature;
a preset identifier in the target parameter information, different preset identifiers corresponding to different fixed values; or
a first default value in the target parameter information as the target fixed value; and
determining a value of the initial grouping step size in the grouping information based on an integer multiple of the target fixed value.

20. The point cloud decoding apparatus according to claim 18, wherein the processing circuitry is configured to:
determine an intermediate value based on:
at least one of the point cloud characteristic information, the bounding box information, or the coding parameter information in the target feature;
a fixed value corresponding to a preset identifier in the target parameter information, different preset identifiers corresponding to different fixed values; or
a second default value in the target parameter information as the intermediate value; and
determining the initial grouping step size based on the intermediate value.
